(19) United States
(12) Patent Application Publication
(10) Pub. No.: US 2019/0363620 A1
(43) Pub. Date: Nov. 28, 2019

(54) System and Method for Inserting Insulation Strips into Slots in Wound Stator

(71) Applicant: Victory Industrial Corporation, New Taipei City (TW)

(72) Inventors: Chun-Yuan WANG, New Taipei City (TW); Chih-Chin CHANG, New Taipei City (TW); Yu-Tang KUAN, New Taipei City (TW)

(21) Appl. No.: 16/372,253

(22) Filed: Apr. 1, 2019

Related U.S. Application Data
(60) Provisional application No. 62/657,403, filed on Apr. 13, 2018.
(60) Provisional application No. 62/657,425, filed on Apr. 13, 2018.
(60) Provisional application No. 62/657,440, filed on Apr. 13, 2018.
(60) Provisional application No. 62/657,453, filed on Apr. 13, 2018.
(60) Provisional application No. 62/790,868, filed on Jan. 10, 2019.

(51) Int. Cl. H02K 15/10; H02K 15/06

(52) U.S. Cl. CPC H02K 15/10; H02K 3/345; H02K 15/067

(57) ABSTRACT

The present disclosure provides a system for inserting insulation strips into slots in a wound stator and a method therefor. The system includes a first provider, a second provider and an inserting component. The first provider is configured to provide a first insulation strip. The second provider is configured to provide a second insulation strip. The inserting component is configured to simultaneously insert the first insulation strip and the second insulation strip spacing apart from the first insulation strip into two slots of the wound stator, respectively. The present disclosure further provides a system for manufacturing a stator core. The system includes a winding mechanism and at least one positioning component. The winding mechanism is configured to wind and release a sheet having several notches at intervals. The at least one positioning component is located under the winding mechanism and corresponds to the notches.

### CROSS REFERENCE TO RELATED APPLICATIONS

This applications claims the benefit of priority from the following US applications, each of which is herein incorporated by reference in their entirety for all purposes:

U.S. provisional patent application 62/657,403 filed Apr. 13, 2018;

U.S. provisional patent application 62/657,425 filed Apr. 13, 2018;

U.S. provisional patent application 62/657,440 filed Apr. 13, 2018;

U.S. provisional patent application 62/657,453 filed Apr. 13, 2018; and

U.S. provisional patent application 62/790,868 filed Jan. 10, 2019.

### TECHNICAL FIELD

In a first embodiment, the present disclosure generally relates to a system and a method for inserting insulation strips into slots in a wound stator. In a second embodiment the present invention relates to a system for manufacturing a stator core.

### BACKGROUND

An existing alternating-current (AC) alternator is typically used for converting mechanical energy into AC electric energy. When a vehicle is equipped with an (AC) alternator, an induced current is generated by the combined operation of a stator and a rotor driven by an engine. Specifically, the rotor includes a coil of wire wrapped around a metal core. Current through the wire coil produces a magnetic field around the metal core. The strength of the field current determines the strength of the magnetic field. The field current may be direct current supplied by brushes and slip rings. When an engine operates, the rotor is accordingly driven to rotate via an alternator pulley coupled to the engine.

A stator has several sets of wire coils wound around a stator core and surrounding the rotor. The stator is fixed to a shell of the alternator, and does not turn. As the rotor turns within the stator windings, the magnetic field of the rotor sweeps through the stator windings, producing an electromotive force that generates an electrical current in the windings. The current can charge a battery for suppling power to other electrical parts in the vehicle. Thus, the mechanical energy generated from an engine is converted into the electrical energy by the use of the alternating-current alternator.

The wire coils are wound around the tooth of the stator core to be partly located within numerous slots defined between every two adjacent tooth of the stator core. An insulation liner or insulation coating is applied to the slots in order to prevent the wires from being in direct contact with the tooth of the stator core, ensuring electrical insulation between the wire and the teeth. Nevertheless, the existing insulation liner within the slot may not entirely encircle the wire such that the wire is exposed via the opening of the slot that faces towards the central axis of the stator core. The wire may be undesirably in contact with the tooth of the stator core near the opening, generating short circuit. Thus, the magnitude of magnetic field generated by the wire may be accidentally affected.

Furthermore, in an existing method of manually assembling a stator, the processes are cumbersome and slow. Such method is inefficient and what are accordingly needed are stator installation systems and methods that assemble stators rapidly and provide the stators with wires that are perfectly electrically insulated against a stator core.

### SUMMARY OF INVENTION

In accordance with an aspect of the present disclosure, a system for inserting insulation strips into slots in a wound stator is provided. The system includes a first provider, a second provider and an inserting component. The first provider is configured to provide a first insulation strip. The second provider is configured to provide a second insulation strip. The inserting component is configured to simultaneously insert the first insulation strip and the second insulation strip spacing apart from the first insulation strip into two slots of the wound stator, respectively.

In accordance with another aspect of the present disclosure, a method for inserting insulation strips into slots in a wound stator is described as follows. A first insulation strip and a second insulation strip spacing apart from the first insulation strip are provided. The first insulation strip and the second insulation strip are simultaneously inserted into two slots of the wound stator, respectively. The wound stator is rotated. A third insulation strip and a fourth insulation strip spacing apart from the third insulation strip are provided. The third insulation strip and the fourth insulation strip are simultaneously inserted into another two slots of the wound stator, respectively wherein the two slots are next to the another two slots.

In accordance with an aspect of the present disclosure, a system for manufacturing a stator core is provided. The system includes a winding mechanism and at least one positioning component. The winding mechanism is configured to wind and release a sheet having several notches at intervals. The at least one positioning component is located under the winding mechanism and corresponds to the notches.

In accordance with another aspect of the present disclosure, a system for manufacturing a stator core is provided. The system includes a winding mechanism and at least one positioning component. The winding mechanism is configured to wind and release a sheet having several notches at intervals. The at least one positioning component is located under the winding mechanism and configured to collect and stack up the sheet to form a stator core having at least one groove made of the notches that are aligned with each other, by matching the notches with the positioning components.

In accordance with yet another aspect of the present disclosure, a system for manufacturing a stator core is provided. The system includes a winding mechanism and at least one positioning component. The winding mechanism includes a disk, an actuator and several engaging components. The actuator is configured to rotate the disk about an axis. The engaging components are coupled to the disk and configured to alternatively protrude out or retract into the disk with the rotation of the disk. The at least one positioning component is located under the winding mechanism, elongated, and is disposed along the direction of the axis.

### BRIEF DESCRIPTION OF THE DRAWINGS

The invention as well as a preferred mode of use, further objectives, and advantages thereof will be best understood by referring to the following detailed description of illustrative embodiments in conjunction with the accompanying drawings, wherein:

FIG. 1 is a top view of a system for inserting insulation strips into slots in a wound stator in accordance with an embodiment of the disclosure;

FIG. 2 is a front view of the system in FIG. 1;

FIG. 3 is a simplified front view of a first provider of the system in FIG. 1;

FIG. 4 is a simplified partial top view of the first provider, a second provider, an inserting component and a rotating component with a stator of the system in FIG. 1;

FIG. 5 is a simplified top view showing an insulation belt being pushed out of a material container towards a conveyor of the first provider in FIG. 1;

FIG. 6 is a simplified partial front view of the first provider in FIG. 1;

FIG. 7 is a simplified partial top view of the system in FIG. 1, two transporting unit of which are being rotated to provide two insulation strips;

FIG. 8A is a simplified front view of a part of the inserting component and a second platform of the system in FIG. 1.

FIG. 8B is a simplified side view of a part of the inserting component and a second platform of the system in FIG. 1.

FIG. 8C is an enlarged view of area A in FIG. 8A,

FIG. 9 is a simplified front view of the inserting component and the expanding mechanism that aligns with the inserting component in the rotating component;

FIG. 10 is a simplified front view showing that the inserting component moves toward the rotating component;

FIG. 11A is a simplified side view of the rotating component, the expanding mechanism and a stator core of the system in FIG. 1;

FIG. 11B is an enlarged view of FIG. 11a;

FIG. 12 is a simplified enlarged side view of the stator core with two slots inserted with insulation strips by the inserting component; and

FIG. 13 is a simplified front view of the rotating component and a transferring mechanism that transports stator cores from and to the rotating component of the system in FIG. 1.

FIG. 14 is a simplified front view of a system for manufacturing a stator core in accordance with an embodiment of the disclosure;

FIG. 15 is an enlarged partial front view of the system taken in box A of FIG. 14;

FIG. 16 is a simplified top view of the system taken in box A of FIG. 14

FIG. 17 is a simplified side view of the system viewed from line I-I of FIG. 16;

FIG. 18 is a simplified rear view of the system viewed from line II-II of FIG. 16;

FIG. 19 is a cross-sectional side view of the system taken along line of FIG. 16;

FIG. 20 is a top view of a cylinder and positioning component of the system in FIG. 14;

FIG. 21 is a simplified side view of the system in which a first segment of a cylinder is disengaged from a second segment of the cylinder in accordance with an embodiment of the disclosure; and

FIG. 22 is a perspective of a stator core in accordance with an embodiment of the disclosure.

### DETAILED DESCRIPTION

The characteristics, subject matter, advantages, and effects of the present disclosure are detailed hereinafter by reference to embodiments of the present disclosure and the accompanying drawings. It is understood that the drawings referred to in the following description are intended only for purposes of illustration and do not necessarily show the actual proportion and precise arrangement of the embodiments. Therefore, the proportion and arrangement shown in the drawings should not be construed as limiting or restricting the scope of the present invention.

The terminology used in the description of the present disclosure herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The present disclosure provides a system for inserting insulation strips into slots in a wound stator. In some embodiments, the wound stator may be installed with a rotor, a housing and several parts, such as rectifier, to form an alternating-current (AC) alternator. The AC alternator may be equipped in a vehicle, for example, car, forklift, hoist, lawn mower, or the like, with a view to providing electrical power for several electronical parts installed in a vehicle, such as lamp, infrared sensor, air conditioner, radio, rear-view camera, or the like.

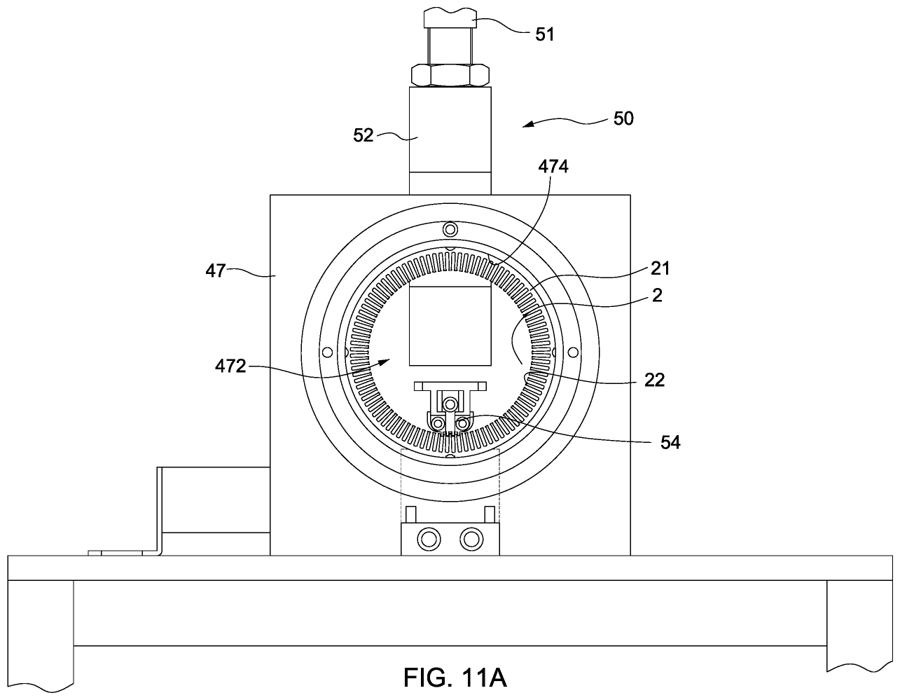

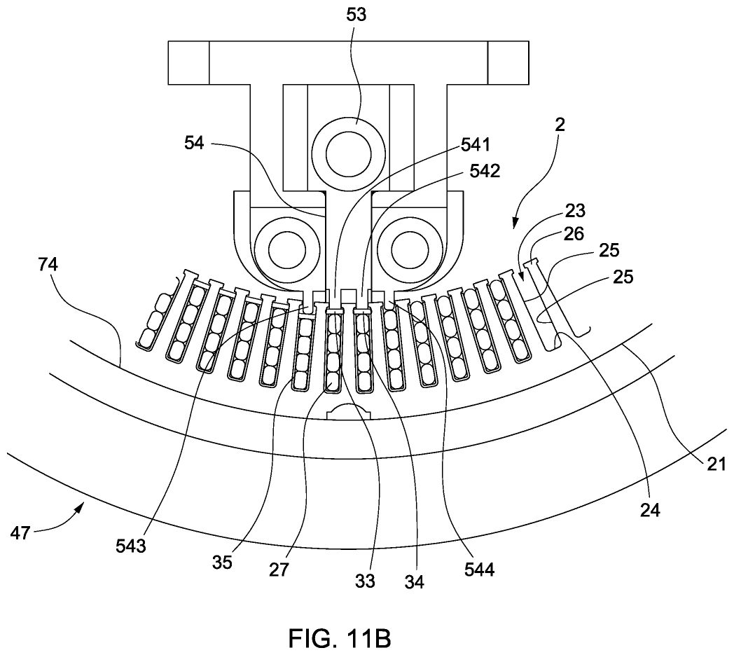

FIG. 11A is a simplified side view of the rotating component, the expanding mechanism and a stator core 21 of a system according to an embodiment of the present disclosure. FIG. 11b is an enlarged view of FIG. 11A. In some embodiments, a stator 2 includes a stator core 21 that is tubular or cylindrical in shape and numerous tooth 22 evenly located on the circumferential surface of the stator core 21. The stator core 21 is made of a long piece of metal sheet that is spirally stacked up and then laminated together. The metal may be aluminum, steel or cast iron. The tooth 22 of the stator core 21 extends inwardly from one side of the stator core 21 towards the central axis of the stator core 21. Numerous slots 23 are formed between two adjacent tooth of the stator core 21. As shown in FIG. 11B, each slot 23 has a bottom surface 24 and two side walls 25 on two opposite sides of the bottom surface 24. The cross-section of the slot 23 may be varied. For example, in this embodiment, the two side walls 25 of a slot 23 are substantially parallel to each other. In some other embodiments, the two side walls 25 are tapered from the free ends of the teeth 22 towards the bottom surface 24. In addition, in some embodiments, the stator core 21 includes two shoes 26 on top of each tooth 22 and protruding in an opposite direction toward two adjacent slots 23 so as to partially cover the opening of the slot 23.

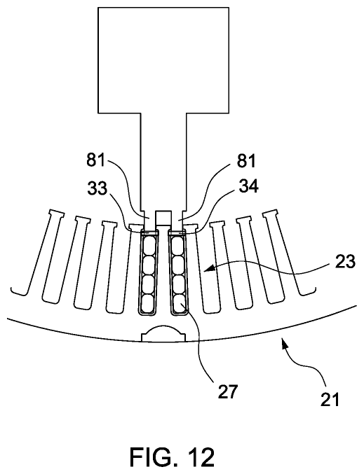

In some embodiments of the disclosure, one or more wires 27 are inserted into the slots 23 from one end of the stator core 21 to the opposite end of the stator core 21. For example, in an AC three-phase alternator, the amount of slots 23 formed in a stator core 21 is 96. This means each phase has thirty-two slots 23 that are inserted and occupied by the wires 27 connected in series. Wires 27 are inserted into and protrude out from one slot 23 and then inserted into another slot 23 at certain pitch (i.e., interval). For example, the two slots 23 in which the wire 27 is inserted in sequence are spaced apart by five slots 23. It is understood that many of the wires 27 are omitted in FIGS. 11A, 11B and 12 in order to clearly illustrate the shape of the slots 23.

In accordance with some embodiments of the disclosure, an insulation liner 35 is inserted into a slot 23 as shown in FIG. 11B in order to cover the bottom surface 24 and the two opposite side walls 25 of the slot 23. The insulation liner 35 is longer than, or has the same length as, the slots 23 and the tooth 22 such that all surfaces 24 and 25 of the slot 23 are fully covered by the insulation liner 35. The material of the insulation liner 35 may be laminated paper, plastic film, polyethylene terephthalate (PET) film, epoxy, aramid, dielectric film, or a combination thereof. Besides, the insulation liner 35 can be replaced with insulation coating which is formed on the surfaces 24 and 25 of the slots 23.

According to some embodiments of the present disclosure as shown in FIG. 11B, a system is provided to simultaneously insert several insulation strips 33 and 34 into slots 23 of a stator core 21. The insulation strips 33 and 34 are inserted into the slots 23 with a view to allowing the insulation strips 33 and 34 to be positioned between the shoes 26 and the wire 27 in the slot 23, or the opening of the slot 23 and the wires 27. Hence, the insulation strips 33 and 34 prevent the wires 27 from exposing through the opening of the slot 23, and what is more, the insulation strip 33 and 34 and the insulation liner 35 together provide a barrier between the wires 27 and the metal stator core 21. The material of the insulation strip 33 and 34 may be the same as, or different from, that of the insulation liner 35. The length of the insulation liner 35 may be longer than, or substantially the same as, that of the slot 23. For example, the insulation liner 35 is three to four centimeters in length and half a millimeter in thickness. Accordingly, thanks to the barrier formed by the combination of the insulation strip 33, 34 and the insulation liner 35, the wire 27 within the slot 23 is not in direct contact with the tooth 22 and the shoes 26 of the stator core 21, thereby improving the induction efficiency when the AC alternator operates.

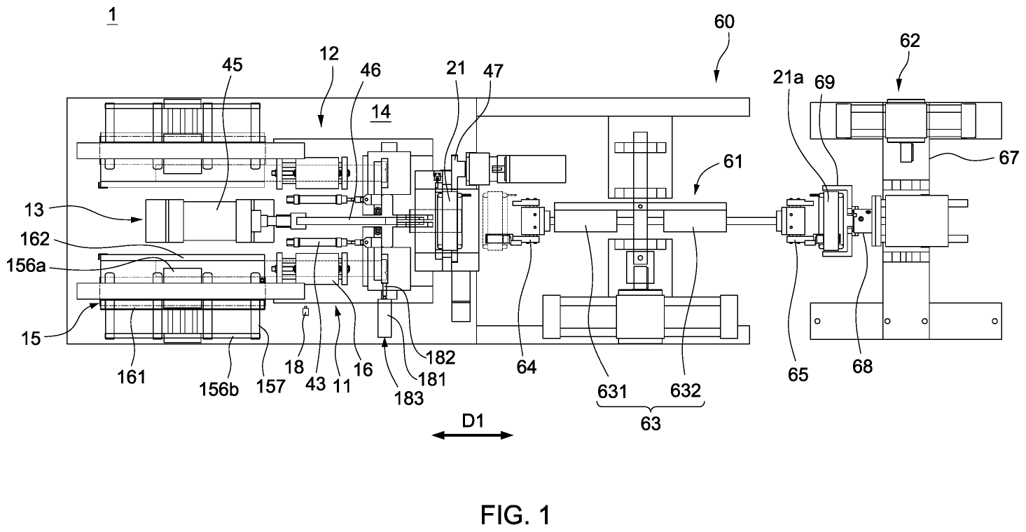

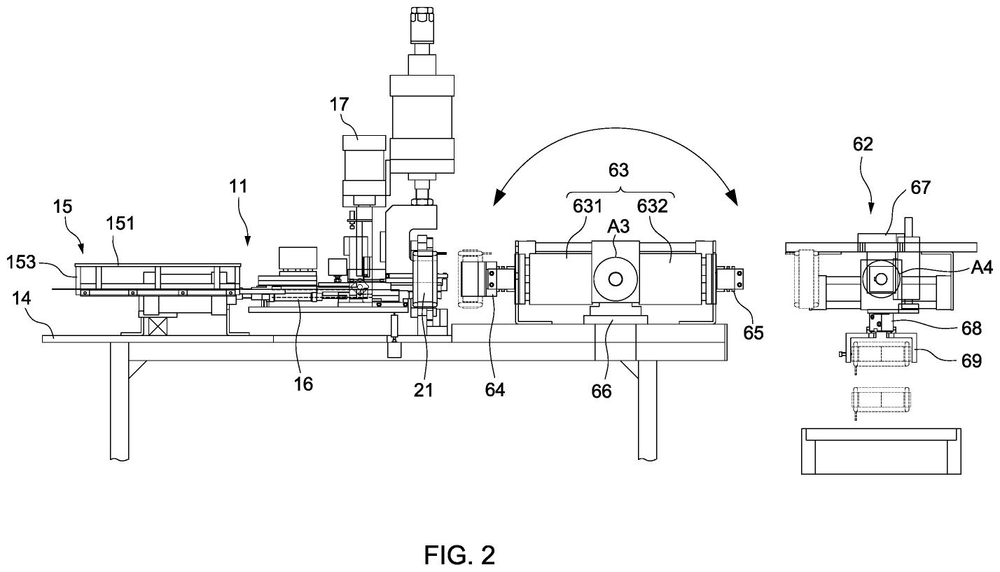

The following describes a system for simultaneously inserting two insulation strips 33 and 34 into slots 23 of a stator core 21 according to an embodiment of the disclosure. FIG. 1 is a top view of a system for inserting insulation strips 33, 34 into slots 23 in a wound stator in accordance with an embodiment of the disclosure. FIG. 2 is a front view of the system in FIG. 1. In one embodiment as shown in FIG. 1, the system 1 further includes a first provider 11, a second provider 12, an inserting component 13 and a base 14. The first provider 11, the second provider 12 and the inserting component 13 are all positioned on the base 14. For example, the base 14 is a work table. The first provider 11 and the second provider 12 are positioned on two opposing sides of the base 14, respectively. The inserting component 13 is positioned between the first provider 11 and the second provider 12. The first provider 11 is configured to provide a first insulation strip 33, and the second provider 12 is configured to provide a second insulation strip 34. The first provider 11 and the second provider 12 provide the first insulation strip 33 and the second insulation strip 34 to positions where the inserting component 13 are able to push both of the first insulation strip 33 and the second insulation strip 34 to move forward.

The configuration of the first provider 11 is symmetrical to that of the second provider 12. To avoid redundancy, we only explain the structures of the first provider 11 below.

In one embodiment of the disclosure as shown in FIG. 2, the first provider 11 further includes a material container 15, a conveyor 16 and a cutting unit 17, each of which is positioned on the base 14.

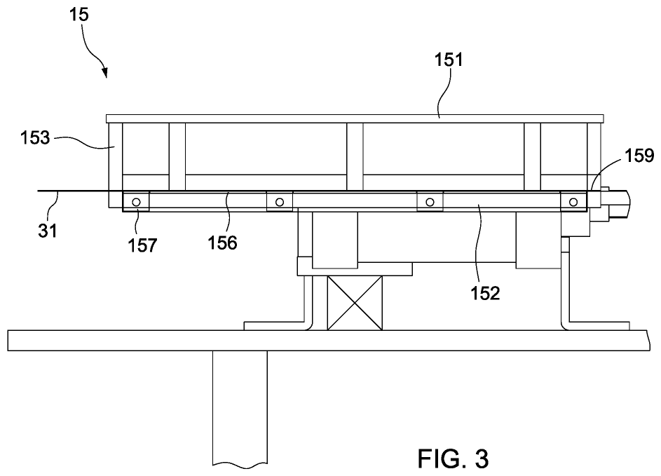

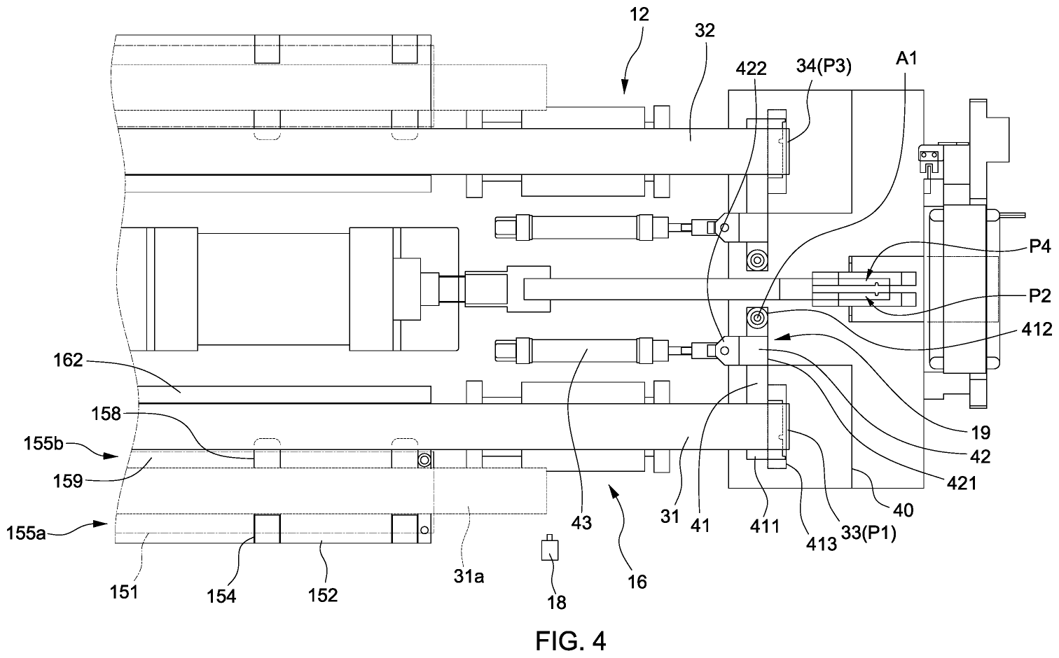

FIG. 3 is a simplified front view of the first provider of the system in FIG. 1. FIG. 4 is a simplified partial top view of the first provider, the second provider, the inserting component and a rotating component with a stator of the system in FIG. 1. In one embodiment as shown in FIGS. 3 and 4, the material container 15 is configured to accommodate numerous insulation belts 31. By means of cutting an insulation belt 31 in sequence into numerous pieces, the insulation strips 33 are formed. The material container 15 has a top plate 151, a bottom plate 152, several columns 153 and a pushing component 154. The columns 153 connect the top plate 151 and the bottom plate 152 to form a space for accommodating the insulation belts 31. The space has four sides, three of which have the columns 153 for confining movements of the insulation belts 31. The insulation belts 31 are placed into the space from the other side having no columns 153. Please refer to FIG. 4. Two opposite sides having the columns 153 are first side 155a and second side 155b. The pushing component 154 is positioned at the second side 155b. The second side 155b has an opening 156 below the corresponding columns 153 (see FIG. 3). The thickness of the opening 156 matches with that of one insulation belt 31 such that the opening 156 allows nothing but one insulation belt 31 to pass through one at a time.

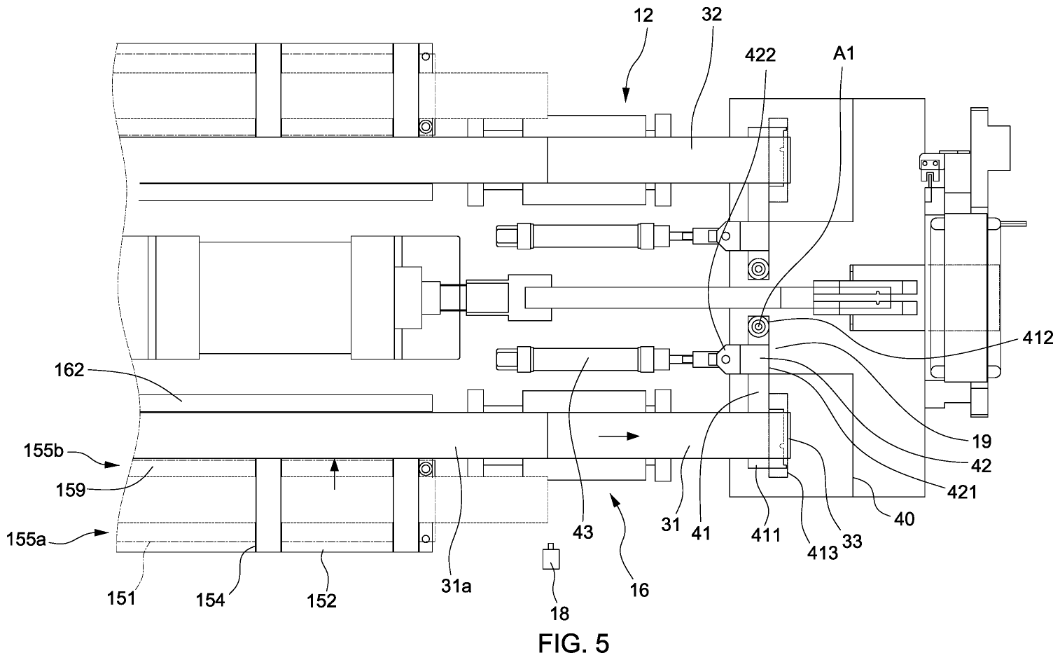

As shown in FIGS. 1 and 3-4, the pushing component 154 has an actuator 156a, a connecting bar 156b and several moving rods 157. The actuator 156a is mounted under the bottom plate 152 and coupled to the connecting bar 156b. The moving rods 157, the amount of which may be four, are coupled to the connecting bar 156b, respectively. The bottom plate 152 has several troughs 158 formed from the first side 155a towards the opposing second side 155b. The troughs 158 are recessed from a top surface 159 of the bottom plate 152. A major portion of the moving rods 157 is movably positioned within the corresponding troughs 158; the other portion of the moving rods 157 juts out of the top surface 159 of the bottom plate 152. The height of the other portion of the moving rods 157 jutting out of the top surface 159 is approximately the same as the thickness of each insulation belt 31. The actuator 156a is configured to drive the connecting bar 156b to move back and forth with a view to pushing the moving rods 157 to move along the troughs 158 from one side towards its opposite side. FIG. 5 is a simplified top view showing an insulation belt 31 being pushed out of the material container 15 towards a conveyor 16 of the first provider 11 in FIG. 1. The bottom one of the insulation belts 31 on the top surface 159 is pushed by the moving rods 157 to be moved out of the space to the conveyor 16 via the opening 156. The length of the trough 158 is designed to allow the moving rods 157 to move in a predetermined distance such that the insulation belt 31 is moved to a desired position, for example, a position at the entrance of the conveyor 16. Moreover, in some embodiments, the material container 15 further includes several blocks 161 and 162 located on the bottom plate 152 configured to confine the movement of the insulation belts 31. For example, a first block 161 is positioned at the first side 155a, and a second block 162 is located on the top surface 159 outside of the material container 15. What with the moving rods pushing an insulation belt 31 to move in a predetermined distance along the trough 158 and what with the blocks 161 and 162 confining the moving insulation belt 31, the insulation belt 31 is precisely stopped at the desired position after being pushed out of the space of the material container 15. The insulation belts 31, consequently, are fed to the conveyor 16 one by one.

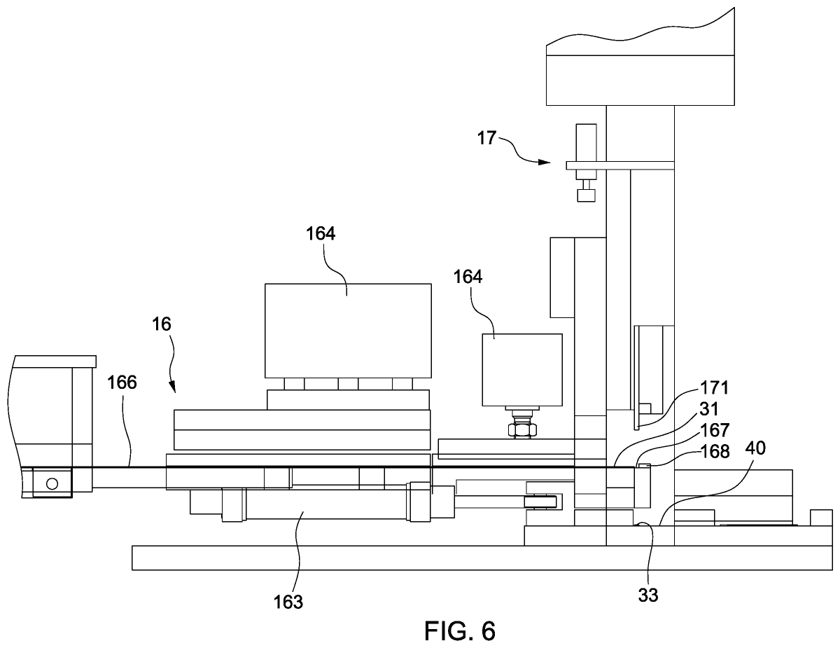

FIG. 6 is a simplified partial front view of the first provider 11 in FIG. 1. Please refer to FIGS. 1 and 6. In some embodiments of the disclosure, the conveyor 16 is configured to convey an insulation belt 31 to the cutting unit 17. The conveyor 16 includes a slider 163 and two pressing components 164. The insulation belt 31 is placed onto a first platform 166 of the slider 163 by the moving rods 157. The pressing components 164 are positioned over the slider 163. The slider 163 is configured to carry the insulation belt 31 to the cutting unit 17. The pressing components 164 are configured to press the insulation belt 31 against the first platform 166 of the slider 163. In an embodiment, only when the insulation belt 31 is pressed by the pressing components 164 can the slider 163 carry the insulation belt 31 and move towards the cutting unit 17. When the pressing components 164 are lifted up and have no long contacts with the insulation belt 31, the slider 163 moves back to its original position.

Referring FIGS. 4-5, in one embodiment of the disclosure, the first provider 11 further includes a material detector 18 electronically coupled to the pushing component 154 and configured to detect a status of the insulation belt 31. In an embodiment, the material detector 18 is positioned next to the conveyor 16 and is configured to detect a movement of the insulation belt 31. For example, the material detector 18 is an infrared sensor that emits infrared light towards a designated spot where the insulation belt 31 is moved towards the cutting unit 17. The material detector 18 detects whether the insulation belt 31 is provided on the spot. When the material detector 18 detects that there is no insulation belt 31 on the spot, which means a major portion of the insulation belt 31 has been processed by the cutting unit 17. The material detector 18 is configured to transmit a signal to the pushing component 154 to feed a new insulation belt 31 to the conveyor 16, as shown in FIG. 5.

In an embodiment of the disclosure as shown in FIG. 6, the cutting unit 17 is configured to cut a part of the insulation belt 31 off to provide an insulation strip 33. The cutting unit 17 includes a blade 171. In some embodiments, the first platform 166 includes an aperture 167 and a stopper 168. The cutting unit 17 is located over the aperture 167. The aperture 167 is formed between the slider 163 and the stopper 168, and the size of the aperture 167 is slightly larger than the width of a single insulation strip 33. In some embodiments, when the conveyor 16 carries the insulation belt 31 to be positioned under the cutting unit 17 and an end of the insulation belt 31 leans against the stopper 168, the cutting unit 17 moves downward to cut the end of the insulation belt 31 into a piece of insulation strip 33. While the insulation belt 31 is cut into a piece of insulation strip 33, the insulation strip 33 falls to a second platform 40 through the aperture 167 by gravitation.

In some embodiment, as shown in FIG. 1, the system 1 further includes a removing component 183 positioned adjacent to the first provider 11. The removing component 183 is configured to remove a remaining portion of an insulation belt 31 that is no longer in use from the conveyor 16. In some embodiments, the removing component 183 includes an actuator 181 and a removing rod 182. The actuator 181 is configured to drive the removing rod 182 to move onto the conveyor 16 with a view to removing an insulation belt 31 from the conveyor 16. In an embodiment, for example, when an insulation belt 31 is cut into several pieces of insulation strips 33 and the insulation belt 31 is too short to be cut off, the system 1 may enable the removing component 183 to remove the remaining insulation belt 31.

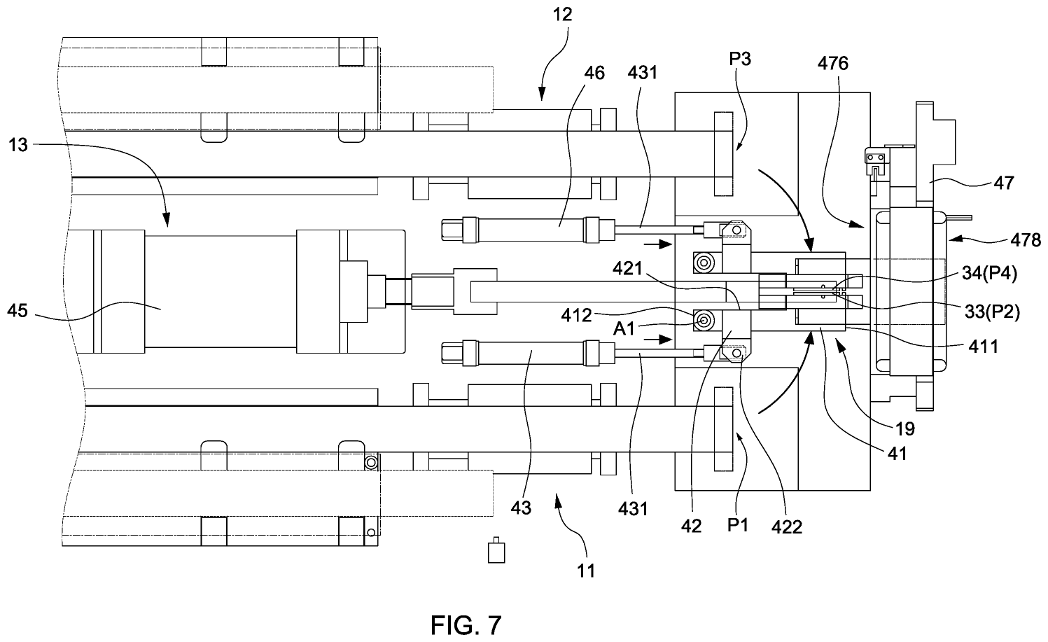

As shown in FIG. 4 and FIG. 7, which is a simplified partial top view of the system in FIG. 1, two transporting units 19 of which are being rotated to provide two insulation strips 33 according to an embodiment of the disclosure, the first provider 11 further includes a transporting unit 19 located on the second platform 40. The transporting unit 19 is configured to move the insulation strip 33 on the second platform 40 from a first position P1 to a second position P2 (see FIG. 7). As shown in FIGS. 4 and 7, the first position P1 is the spot where the insulation strip 33 falls from the first platform 166 via the aperture 167 to the transporting unit 19; the second position P2 is a spot in front of the inserting component 13. In some embodiments, the transporting unit 19 is configured to pivot about a right angle to move the insulation strip 33 from the first position P1 to the second position P2. As shown in FIG. 7, the transporting unit 19 includes a pivoting rod 41, a joint rod 42, and an actuator 43. The pivoting rod 41 has two opposite ends including a first end 411 and a second end 412. An insulation strip 33 is placed or falls onto or near the first end 411 of the pivoting rod 41. The joint rod 42 has a third end 421 affixed to a part of the pivoting rod 41 between the first end 411 and the second end 412. A fourth end 422 of the joint rod 42 is connected to an end of the actuator 43. The actuator 43 is configured to drive the pivoting rod 41 and the joint rod 42 to pivot about an axis A1 in the second end 412 of the pivoting rod 41. In some embodiments, the other end of the actuator 43 is movably screwed on the second platform 40. When the actuator 43 operates, a rod 431 extends out therefrom so that the pivoting rod 41 and the joint rod 42 smoothly rotate. In some embodiments, the pivoting rod 41 further includes a limiting block 413 on the first end 411 configured to limit an undesirable movement of the insulation strip 33.

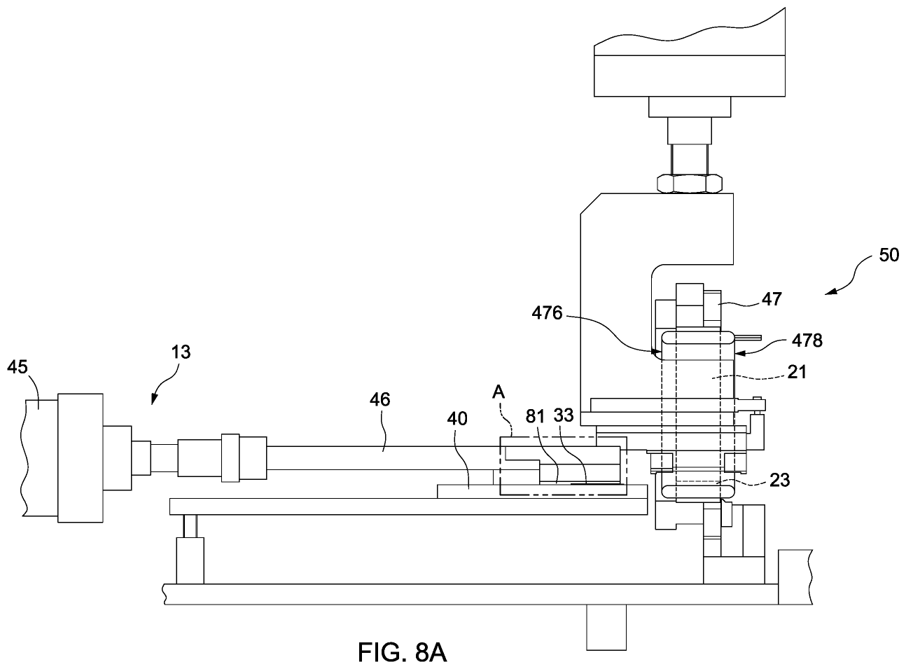

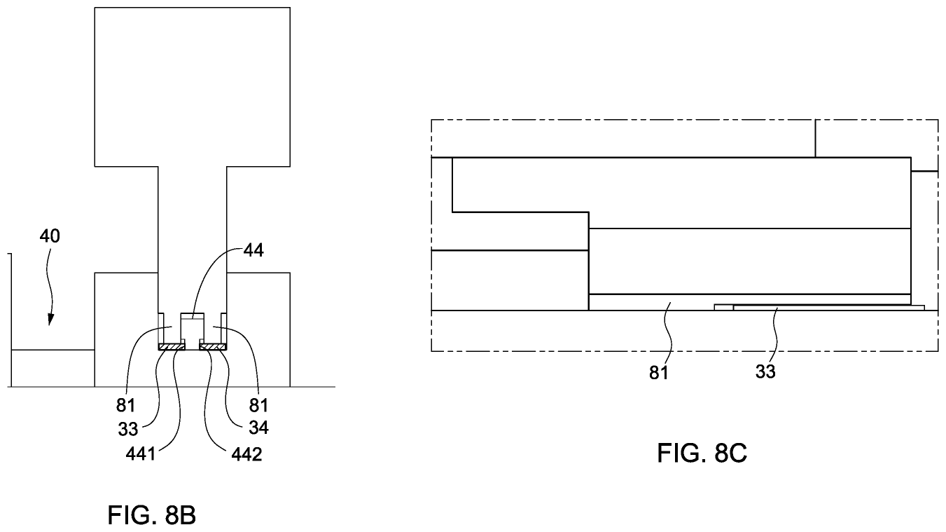

FIG. 8B is a simplified side view of a part of the inserting component 13 and a second platform 40 of the system in FIG. 1. In one embodiment as shown in FIG. 8b, the second platform 40 includes a partition 44 on an upper surface thereof. The partition 44 has two opposing sides 441, 442 and is located between the first provider 11 and the second provider 12 and near the second position P2. When the first provider 11 and the second provider 12 feed two insulation strips 33 and 34, one of the insulation strips 33 leans against one side 441 of the sides of the partition 44, and the other insulation strip 34 leans against the other side 442 of the partition 44. Hence, the partition 44 is configured to separate two insulations 33 and 34 at a distance. In some embodiments, the width of the partition 44 substantially equals a width of a tooth 22 of a stator core 21.

Referring to FIGS. 4 and 7. The actuator 43 is operated to retreat the pivoting rod 41 and the joint rod 42 so that they are back to their original positions for receiving another insulation strip 33 to be fed. The transporting unit 19 then performs the same process to move said another insulation strip 33 from the first position P1 to the second position P2.

FIG. 8A is a simplified front view of a part of the inserting component 13 and a second platform 40 of the system in FIG. 1. As shown in FIGS. 7 and 8A, in accordance with some embodiments of the disclosure, the inserting component 13 is located on the second platform 40 and positioned between the first provider 11 and the second provider 12. The first provider 11 and the second provider 12 are configured to feed insulation strips 33 and 34 to be placed in front of the inserting component 13. The two insulation strips 33 and 34 are positioned side by side and spaced apart from each other by a distance. The inserting component 13 is configured to simultaneously insert two insulation strips 33 and 34 provided from the first provider 11 and the second provider 12 into two slots 23 of the wound stator, respectively.

In some embodiments, the inserting component 13 includes an actuator 45 and an inserting rod 46 connected to the actuator 45. The actuator 45 is configured to drive the inserting rod 46 to move back and forth between the second position P2 and a space surrounded by a rotating component 47. Thus, the inserting rod 46 can simultaneously push two insulation strips 33 and 34 into two slots 23 of the stator core 21 that are adjacent to each other. After the two insulation strips 33 and 34 are inserted into the two slots 23, the actuator 45 drives the inserting rod 46 to move back to the second position P2. Then, the inserting rod 46 may perform the same process of inserting other two insulation strips 33 and 34 into other two slots 23 of the stator core 21 for numerous times until all slots 23 are inserted with the insulation strips 33 and 34. Since the inserting component 13 disclosed in some embodiments of the disclosure is able to insert two insulation strips 33 and 34 into two slots 23 at the same time, the manufacturing efficiency is greatly increased. In other embodiments, in response to an actual demand, the inserting component 13 can be designed to simultaneously insert different numbers of insulation strips 33 and 34 into numerous slots 23, for example, one, three, four, five, and the like.

As shown in FIG. 8B, in some embodiments, the inserting component 13 includes two protruding parts 81 mounted on the inserting rod 46. The protruding parts 81 may be plungers. The protruding parts 81 each have a width slightly greater than that of each of the slots 23 of the wound stator 2. As shown in FIG. 8C, which is an enlarged view of area A in FIG. 8A, the insulation strip 33 is engaged with a notch in a corner of the protruding part 81. When the actuator 45 drives the inserting rod 46 and the protruding parts 81 move towards the rotating component 47, the two protruding parts 81 are inserted into one side of two slots 23 to deform the slots 23. The two slots 23 are expanded to ensure that the two insulation strips 33 and 34 can be smoothly inserted into the slots 23 of the wound stator 2 by the two protruding parts 81. Furthermore, since the stator core 21 is made from metals with good resilient property, while the protruding parts 81 moves out of the slots 23, the teeth 22 spontaneously restore to their original shapes. This means the slots 23 and the teeth 22 are temporarily deformed when the protruding parts 81 are inserted the slots 23. On the other hand, as shown in FIGS. 11A and 11B, as this moment, the two insulation strips 33 and 34 remain in the slots 23 and between the shoes 26 and wires 27. In other embodiments, the two insulation strips 33 are on top of the slots 23.

As shown in FIGS. 8A, 11A and 11B, the system 1 further includes an expanding mechanism 50 positioned next to the inserting component 13. The expanding mechanism 50 includes a vertical actuator 51, an arm 52, a horizontal actuator 53 and an expanding guide rod 54. The vertical actuator 53 is connected to an end of the arm 52 for driving the arm 52 to move vertically. The other end of the arm 52 may be inserted into the space 472 that accommodates a stator core 21 with wires 27. For example, the arm is C-shaped. In some embodiments, the horizontal actuator 53 and the expanding guide rod 54 are both mounted at the end of the arm 52. The horizontal actuator 53 is configured to drive the expanding guide rod 54 to move horizontally. The expanding rod 54 has two guide bars 541 and 542 that protrude downward and correspond to two slots 23 of the stator core 21 that are ready for insertions. Each of the guide bars 541 and 542 has a width greater than that of each slot 23. In some embodiments, the position of two slots 23 to be inserted is situated, for example, at the bottom side of the cylindrical space 472. When the horizontal actuator 53 drives the arm 52 and the expanding guide rod 54 to move downward, the guide bars 541 and 542 are inserted into the corresponding slots 23 to expand the width of the slots 23 and press the wire 27 towards the bottom of the slots 23. In some other embodiments, the expanding guide rod 54 further includes two ancillary guide bars 543 and 544 disposed on two opposing sides of the guide bars 541 and 542. As shown in FIG. 11B, the ancillary guide bar 543 positioned at the left of guide bar 541 is for enhancing the insertion of the insulation strip in the slot 23 while the ancillary guide bar 544 positioned at the right of guide bar 542 is for ensuring that the next slots 23 adjacent to the already inserted two slots will be aligned with the guide bars 541 and 542.

In some embodiments, the guide bars 541 and 542 are inserted into the slots 33, 34 for to expand the width of the slots 23 first and then the inserting component 13 pushes the expanding guide rod 54 having the guide bars 541 and 542 out of the slots 23 to occupy the slots 23 where the guide bars 541 and 542 are located. While the inserting component 13 is in the two slots 23, the insertion strips 33 and 34 engaged with the notch in a corner of the protruding part 81 are spontaneously inserted into the two slots 23. The expansion of two slots 23 facilitates smooth insertion of two insulation strips 33 and 34 thanks to the insertions of the guide bars 541 and 542 of the expanding guide rod 54 in advance. In some embodiments, after being pushed out of the slots 23, the expanding guide rod 54 having the guide bars 541 and 542 is lifted up by the vertical actuator 51 and returned to be within the rotating component 47 by the horizontal actuator 53, namely, the original position.

The rotating component 47 is configured to accommodate and rotate the wound stator 2 for sequent insertions of the insulation strips 33 and 34. The rotating component 47 has an inner circumferential wall 474 that is defined to have a cylindrical space 472 therein having two opposite openings, i.e., a first opening 476 and a second opening 478, as shown in FIGS. 7-8. The profile of the inner circumferential wall 474 matches the silhouette of a stator core 21. As shown in FIGS. 11A and 11B and mentioned, a wound stator 2 is attached or tightly fitted into the space 472 for sequent insertions of the insertions strips 33 and 34. The wound stator 2 has 96 teeth 22 radially distributed in the circumferential surface 474 thereof, and 96 slots 23 are formed between the every two adjacent teeth 22. Each slot 23 extends in an axial direction of the wound stator 2. When two insulation strips 33 and 34 have been inserted into two slots 23, the rotating component 47 rotates about a predetermined angle to cause other two slots 23 adjacent to the two inserted slot 23 to align with the inserting component 13 such that the inserting component 13 may insert the other two insulation strips into the other two slots 23. For example, in some embodiments, since the number of the slots 23 of the wound stator is 96, the predetermined angle of rotation is about 7.6 degrees, and the wound stator needs to rotate for 47 times to finish the insertion process. Until all slots 23 have been inserted by the insertion strips, the wound stator 2 is taken out of the rotating component 47, and another wound stator 2 is provided to the rotating component 47 for performing another insertion process.

Referring FIGS. 1-2 and 13, which is a simplified front view of the rotating component 47 and a transferring mechanism 61 that transports stator cores from and to the rotating component of the system in FIG. 1. According to some embodiments of the disclosure, the system 1 further includes a transferring mechanism 60 adjacent to the rotating component 47. The transferring mechanism 60 is configured to place the wound stator 2 to the rotating component 47 for insertions of the insulation strips 33 and 34. The transferring mechanism 60 is also configured to remove a wound stator 2 with numerous insulation strips 33 and 34 from the rotating component 47.

In accordance with some embodiments of the disclosure, the transferring mechanism 60 includes a first robotic device 61 and a second robotic device 62. The first robotic device 61 is positioned in the vicinity of the rotating component 47. The second robotic device 62 is positioned in the vicinity of the first robotic device 61. In some embodiments, the first robotic device 61 is positioned between the rotating component 47 and the second robotic device 62.

In some embodiments of the disclosure, the first robotic device 61 includes a first arm 63, a first claw 64, a second claw 65, and a base 66. The first arm 63 is pivoted to an axle A3 of the base 66 such that the first arm 63 is configured to be rotatable for at least 180 degrees about the base 66. In some embodiments, the first arm 63 is rotatable for 360 degrees in both clockwise and counterclockwise directions. The first claw 64 and the second claw 65 connected to the two ends of the first arm 63, respectively. Both the first claw 64 and the second claw 65 are configured to carry a wound stator 2 to the rotating component 47 and remove a wound stator 2 from the rotating component 47. In addition, the first arm 63 has two cylinders 631 and 632 on the two opposing sides thereof. The cylinders 631 and 632 are configured to stretch the first claw 64 and the second claw 65 out towards the rotating component 47 or the second robotic arm 62 with a view to grasping a wound stator from a predetermined position, or placing a wound stator 2 to the predetermined position.

In some embodiments of the disclosure, the second robotic device 62 is configured to provide a wound stator 2 to the first robotic device 61 and receive a wound stator 2 from the first claw 64 and the second claw 65 of the first robotic device 61. Also, the second robotic device 62 is configured to place a wound stator 2 received from the first robotic device 61 to a collecting device, for example, a receptacle, container cabin, a conveyor 16 or the like, for the next manufacturing process. In some embodiments, the second robotic device 62 includes a second base 67, a second arm 68 and a third claw 69. The second arm 68 is pivoted to an axle A4 of the second base 67 as shown in FIG. 2 such that the second arm 68 is configured to be rotatable for at least 90 degrees about the second base 67. The third claw 69 is mounted on the second arm 68. The third claw 69 is configured to grasp a wound stator 2, separately receive a wound stator 2 from the first claw 64 or the second claw 65, and release a wound stator 2 to said another device.

The following describes a method for inserting insulation strips 33 and 34 into slots 23 in a wound stator 2. The method may, but not limited to, be performed using the foregoing system 1.

In some embodiments of the disclosure, firstly, as shown in FIG. 4, a first insulation strip 33 and a second insulation strip 34 that is spacing apart from the first insulation strip 33 are provided. In some embodiments, the first provider 11 provides the first insulation strip 33, and the second provider 12 provides the second insulation strip 34. In terms of each of the first provider 11 and the second provider 12, two conveyors 16 convey (i.e., carry) a first and a second insulation belts 31 and 32 to be positioned under the cutting unit 17. Every time a portion of the first insulation belt 31 or a portion of the second insulation belt 32 is moved under their respective cutting units 17, the cutting units 17 cut the portion of the first insulation belt 31 and the second insulation belt 32 off into a piece of the first insulation strip 33 or a piece of the second insulation strip 34.

In some embodiments, as shown in FIG. 5, when detecting all remaining part of the insulation belt 31 is moved to the right side of the material detector 18, the material detector 18 transmits a signal to the pushing component 154, indicating that the insulation belt 31 is running out. In response to the signal, the pushing component 154 pushes another insulation belt 31a out of the material container 15 to the conveyor 16. Then the conveyor 16 carries said another insulation belt 31a to be under the cutting unit 17 for repeating another cutting process. Said another insulation belt 31a is cut off into pieces in sequence by the cutting unit 17 again.

In some embodiments, as shown in FIG. 6, after the two cutting units 17 cut the first insulation belt 31 and the second insulation belt 32 off into a piece of first insulation strip 33 and a piece of the second insulation strip 34, the two insulation strips 33 and 34 fall from the first platform 166 to a first position and a third position on the second platform 40 through the respective apertures 167 by gravitation.

In some embodiments, as shown in FIG. 7, after cutting a part of the first insulation belt 31 off to provide the first insulation strip 33, the first insulation strip 33 is transported from the first position P1 to a second position P2. Similarly, the second insulation strip 34 is transported from the third position P3 to a fourth position P3. In one embodiment, the first insulation strip 33 and the second insulation strip 34 are rotated to the second position P2 and the fourth position P4 by a right angle, i.e., 90 degrees. In addition, the second position P2 and the fourth position P4 are separated by the partition 44 (as shown in FIG. 8B). When the first and second insulation strips 33 and 34 are rotated by the two transporting units 19, the partition 44 and the limiting block 413 (as shown in FIG. 4) on the first end of the pivoting rod 41 limit the moving of the first and second insulations strips 33 and 34 so as to correctly locate the first and second insulation strips 33 and 34 to the second and the fourth positions P2, P4.

As shown in FIG. 1, in some embodiments, the transferring mechanism 60 places a stator core 21 having numerous slots 23 into the space 472 within the rotating component 47. The first robotic device 61 of the transferring mechanism 60 stretches the first arm 63 out to reach the space 472 within the rotating component 47. Then the first claw 64 places a stator core 21 to fit with the inner circumference of the rotating component 47 as shown in FIG. 8A,

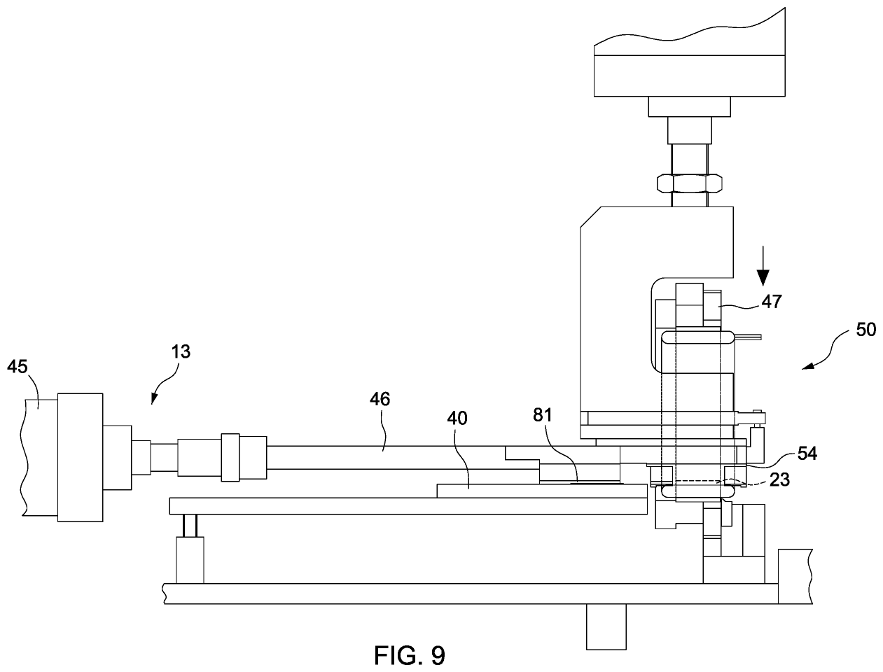

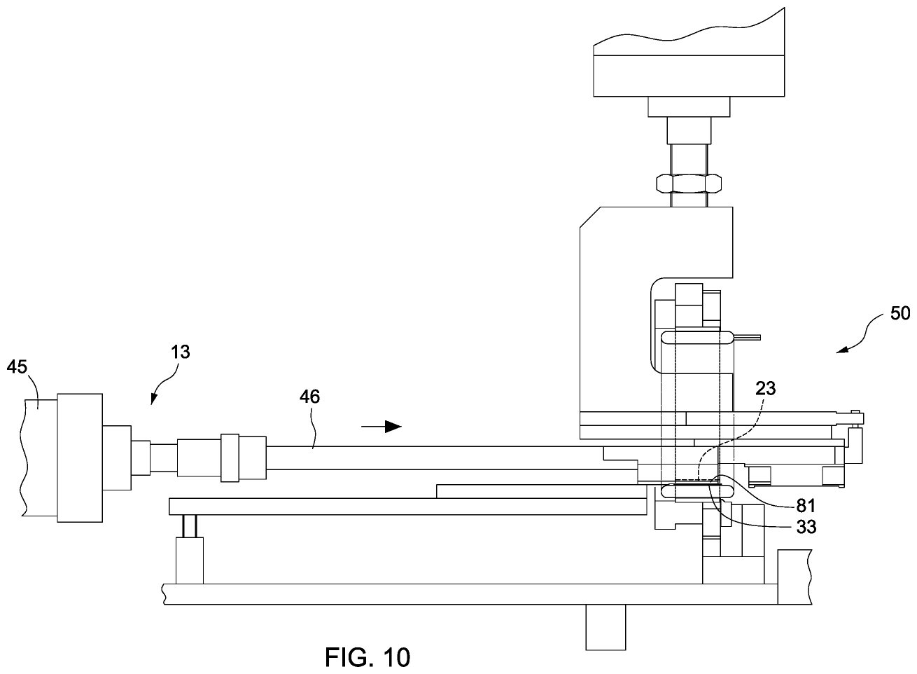

As shown in FIGS. 9, 11A and 11B, afterwards, in some embodiments, the widths of the two of the slots 23 of the stator core 21 are expanded by the expanding mechanism 50, which utilizes its guide rods 54 having the guide bars 541 and 542 to be inserted into the two slots 23 in a radial direction of the stator core 21.

As shown in FIG. 12, which is a simplified enlarged side view of the stator core 21 with two slots 23 inserted with insulation strips 33, 34 by the inserting component 13, then, the first insulation strip 33 and the second insulation strip 34 are simultaneously inserted into two slots 23 of a stator core 21, respectively. In some embodiments, it is the protruding parts 81 of the inserting component 13 that pushes the first insulation strip 33 and the second insulation strip 34 in an axial direction of the stator core 21. Where the foregoing expansion step is performed in advance, the inserting rod 46 with the protruding parts 81 pushes the guide rods 54 guide rods 54 having the guide bars 541 and 542 out through in the axial direction of the stator core 21 and the protruding parts 81 together with the strips 33, 34 take the previous position where the guide bars 541 and 542 of the expanding guide rods 54 are located, so that the slots 23 remain in a widened status.

In some embodiments of the disclosure, after the first insulation strip 33 and the second insulation strip 34 are inserted into the two slots 23, the inserting component 13 retreats out of the two slots 23. The two slots 23 are then restored to their original shapes. And then other two insulation strips 33 and 34 are prepared by the transporting unit 19 for another insertion process. In addition, after being pushed out of the slots 23, the two guide bars 541 and 542 of the expanding guide rod 54 of the expanding mechanism 50 return to its original position within the rotating component 47 as shown in FIG. 8A.

Because the slots 23 are widened before the inserting component 13 pushes the first insulation strip 33 and the second insulation strip 34 into the two slots 23, this expansion insertion step allows the first insulation strip 33 and the second insulation strip 34 to be smoothly inserted into the slots 23.

The present invention additionally includes the following In some embodiments, once the first insulation strip 33 and the second insulation strip 34 are inserted into the two slots 23, the rotating component 47 rotates the stator core 21 by a predetermined degree with a view to aligning two other slots 23 with the inserting component 13 for another insertion process. In some embodiments, the other two slots 23 ready for insertion are next to the two inserted slots 23. After the other two slots 23 are inserted by other two insulation strips (e.g., a third insulation strip and a fourth insulation strip) fed by the first provider 11 and the second provider 12, the stator core 21 may be rotated again for another insertion process.

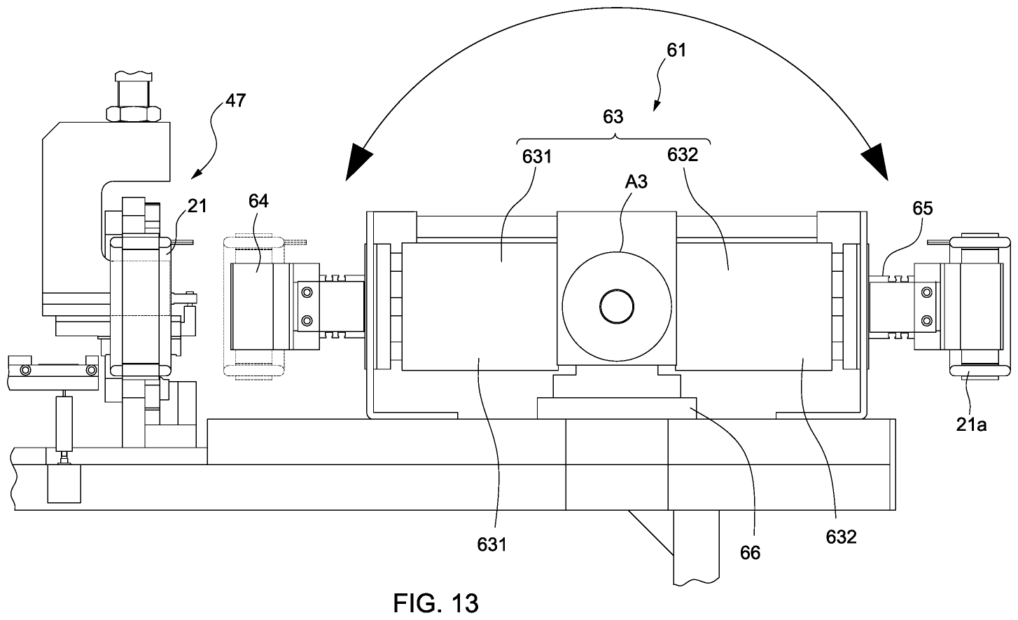

As shown in FIG. 13, in some embodiments of the disclosure, after all the slots 23 of the stator core 21 are inserted with the insulation strips 33 and 34, the first robotic device 61 of the transferring mechanism 60 removes the stator core 21 from the rotating component 47. In some embodiments, the first arm 63 rotates by 180 degrees, and then the second claw 65 is stretched out to grasp the stator core 21 with the insulation strips 33 and 34 (i.e., first stator core 21). As shown in FIGS. 1 and 2, the first claw 64 grasps another stator core (i.e., second stator core 21a) from the second robotic device 62. Not until the first claw 64 grasps the second stator core 21a without any insulation strips and the second claw 65 grasps the first stator core 21 with the insulation strips 33 and 34 does the first arm 63 rotate by 180 degrees again. Then, the second claw 65 places the second stator core 21a into the space within the rotating component 47, and the first claw 64 provides the first stator core 21 to the second robotic device 62. In other words, the first robotic device 61 can transport a stator core without any insulation strips from the second robotic device 62 to the rotating component 47 from insertion process as well as transporting a stator core 21 with numerous insulation strips 33 and 34 from the rotating component 47 to the second robotic device 62.

In some embodiments of the disclosure, the second robotic device 62 is configured to provide a stator core without any insulation strips and receive a stator core 21 with numerous strips 33 and 34. As shown in FIG. 1, the second arm 68 of the second robotic device 62 aligns the third claw 69 with the first claw 64 or the second claw 65 and is then rotated by 90 degrees to align with a collecting device at another position. With the rotation of the second arm 68, the third claw 69 may grasp or provide a stator core 21 to and from first robotic device 61 and the receiving device.

In some embodiments of the disclosure, as shown in FIG. 1, the direction in which the conveyor 16 carries an insulation belt 31 and move is substantially parallel to the direction in which the inserting component 13 pushes insulation strips 33 and 34 into the slots 33, 34 of the stator core 21, so the system can be compact. Moreover, the system 1 can be more compact in that the long side of the first arm 63 and that of the second arm 68 is substantially parallel to the foregoing directions to allow the configurations of most of the devices to extend along the same direction D1 as shown in FIG. 1.

To sum up, in accordance with some embodiments of the disclosure, the use of insulation strips may enhance the insulation between wires and a stator core so as to reduce the magnetic resistance, thereby improving the power generation efficacy. Furthermore, since two insulation strips are inserted into two slots of a stator core simultaneously, the insulation-strip insertion process can be performed faster than a conventional process that the strips must be inserted one by one. In addition, numerous insulation belts only need to be manually placed into two material containers 15. And then the system can automatically cut the insulation belts off into pieces of insulation strips which then are inserted into two slots 23 at the same time. The finished wound stator with insertion strips are placed in a collecting device for storage. The system and its methods, accordingly, improve the manufacturing quality and save the labor cost.

### System for Manufacturing Stator Core

An existing alternator is typically used for converting mechanical energy into alternating-current electrical energy. When a vehicle is equipped with an alternator, an induced current is generated by the combined operation of a stator and a rotor driven by an engine. Specifically, the rotor includes a coil of wires wrapped around a metal core. Currents through the wire coil produce a magnetic field around the metal core. The strength of the field current determines the strength of the magnetic field. The field current may be a direct current supplied by brushes and slip rings. When an engine operates, the rotor is accordingly driven to rotate via an alternator pulley coupled to the engine.

A stator may have several sets of wire coils wound around a stator core and surrounding the rotor. The stator is fixed to a housing of the alternator, and does not turn. As the rotor turns within the stator windings, the magnetic field of the rotor sweeps through the stator windings, producing an electromotive force that generates an electrical current in the stator windings. This current can charge a battery for supplying power to other electrical parts in the vehicle. Hence, the mechanical energy generated from an engine is converted into electrical energy by the use of the alternating-current alternator.

In an existing method for manufacturing a cylindrical stator core, a metal sheet is helically wound around an axis so as to form a layered structure with a cylindrical shape. Teeth of this layered structure, however, may not be correctly aligned because the metal sheet has an elastic property, and has a tendency to slightly restore or bounce back to its original shape, i.e., straight shape.

Thus, an installation worker needs to manually align each layer of the structure with each other before welding them together to form a stator core. This manual process, however, requires arduous effort and meticulous skills, and can be time-consuming as well as comparatively expensive.

What is needed, therefore, is a stator manufacturing system that fabricates and installs stator cores rapidly and efficiently with a lower cost.

In accordance with an aspect of the present disclosure, a system for manufacturing a stator core is provided. The system includes a winding mechanism and at least one positioning component. The winding mechanism is configured to wind and release a sheet having several notches at intervals. The at least one positioning component is located under the winding mechanism and corresponds to the notches.

In accordance with another aspect of the present disclosure, a system for manufacturing a stator core is provided. The system includes a winding mechanism and at least one positioning component. The winding mechanism is configured to wind and release a sheet having several notches at intervals. The at least one positioning component is located under the winding mechanism and configured to collect and stack up the sheet to form a stator core having at least one groove made of the notches that are aligned with each other, by matching the notches with the positioning components.

In accordance with yet another aspect of the present disclosure, a system for manufacturing a stator core is provided. The system includes a winding mechanism and at least one positioning component. The winding mechanism includes a disk, an actuator and several engaging components. The actuator is configured to rotate the disk about an axis. The engaging components are coupled to the disk and configured to alternatively protrude out or retract into the disk with the rotation of the disk. The at least one positioning component is located under the winding mechanism, elongated, and is disposed along the direction of the axis.

The present disclosure provides a system for manufacturing a stator core of a wound stator of an alternator. In some embodiments, the wound stator is installed with a rotor, a housing, and several parts, such as a rectifier, to form an alternator; i.e., an alternating-current generator. A vehicle may be equipped with the alternator, for example, a car, forklift, hoist, lawn mower, and the like, with a view to providing electrical power for several electronic parts installed in a vehicle, such as lamps, infrared sensor, air conditioner, radio, rear-view camera, and the like.

Typical passenger vehicles and light truck alternators may use Lundell or “claw-pole” field construction. Such field construction uses a shaped metal core on the rotor to produce a multi-pole field from a single coil winding. The poles of the rotor resemble fingers of two hands interlocked with each other. The coil is mounted axially inside this, and field current is supplied by slip rings and carbon brushes. These alternators have their field and stator windings cooled by axial airflow, produced by an external fan attached to a drive belt pulley.

The stator has several sets of wire coils wound around a stator core that surrounds the rotor. The stator core is cylindrical in shape and has numerous teeth formed on the circumference surface of its core body. The teeth extend from the core body towards the axis of the rotor. Numerous slots are defined between every two adjacent teeth, respectively. The wires are inserted into the slots and wound around the teeth to form several coils. Then, the coils may be connected to a rectifier configured to convert a direct current into an alternating current.

In accordance with some embodiments of the disclosure, the stator may be made of a straight laminated metal sheet that is wound around and stacked up (i.e., piled up) with each other to form the cylindrical shape. In one embodiment, firstly, a roll of metal sheet is unrolled and straightened. Then, numerous notches are formed in one side of the straight metal sheet by means of stamping, pressing, punching, or the like. The metal sheet is then wound around an axis and stacked up. At this time, the notches are aligned with each other in order to form numerous grooves circumferentially arranged on the outer side of a stator core. Afterwards, the layered metal sheet is bonded layer by layer by means of, for example, a welding or a soldering process in order to form the stator core.

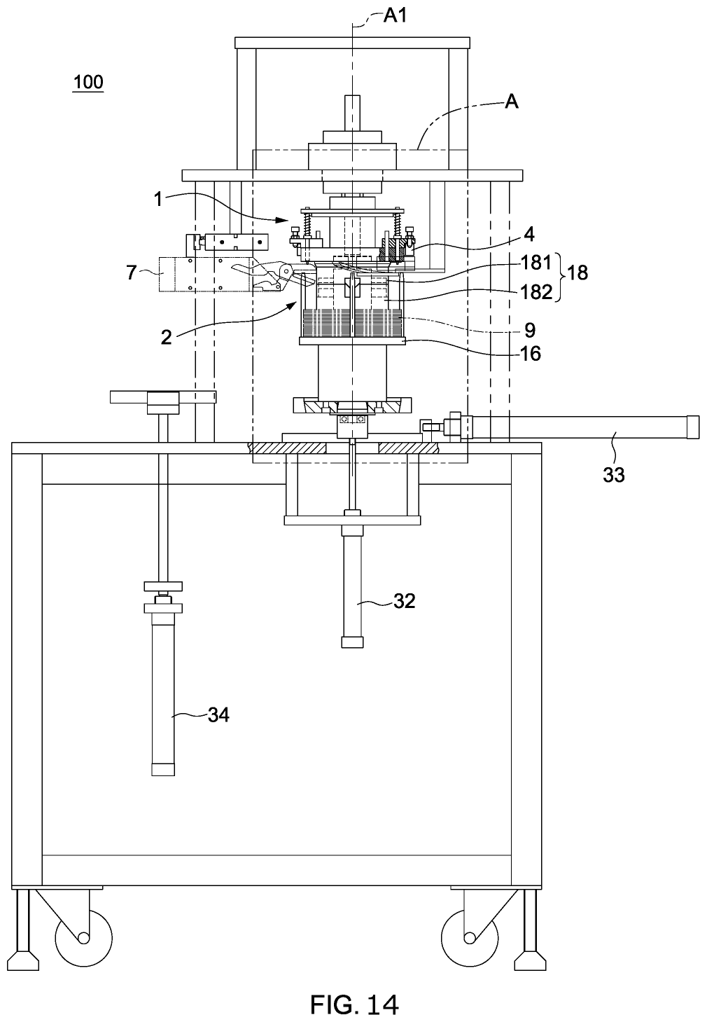

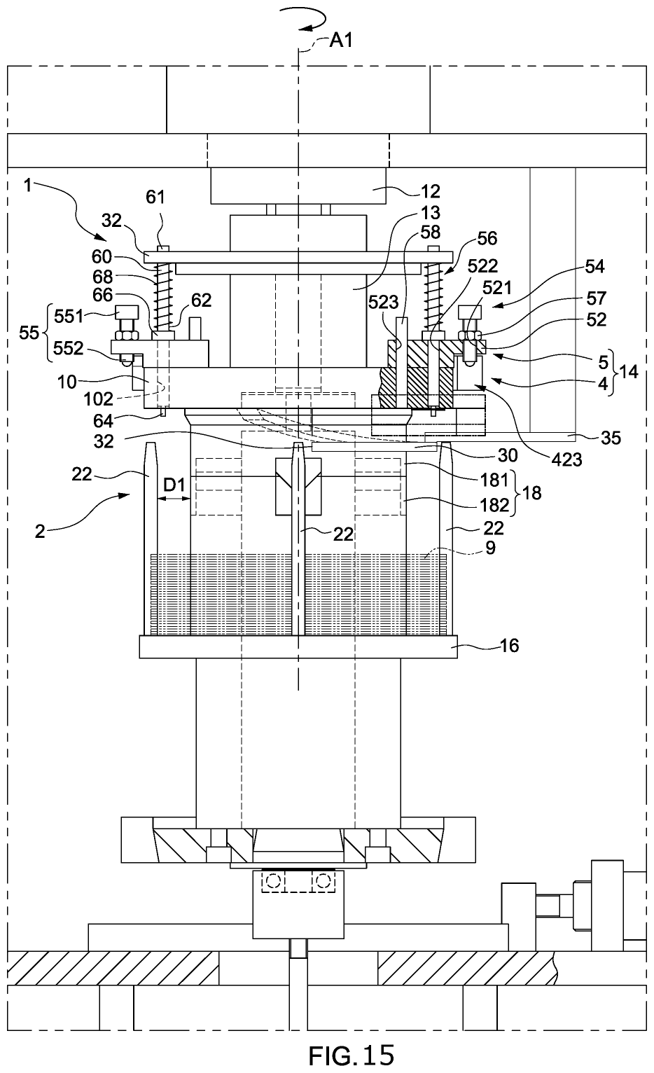

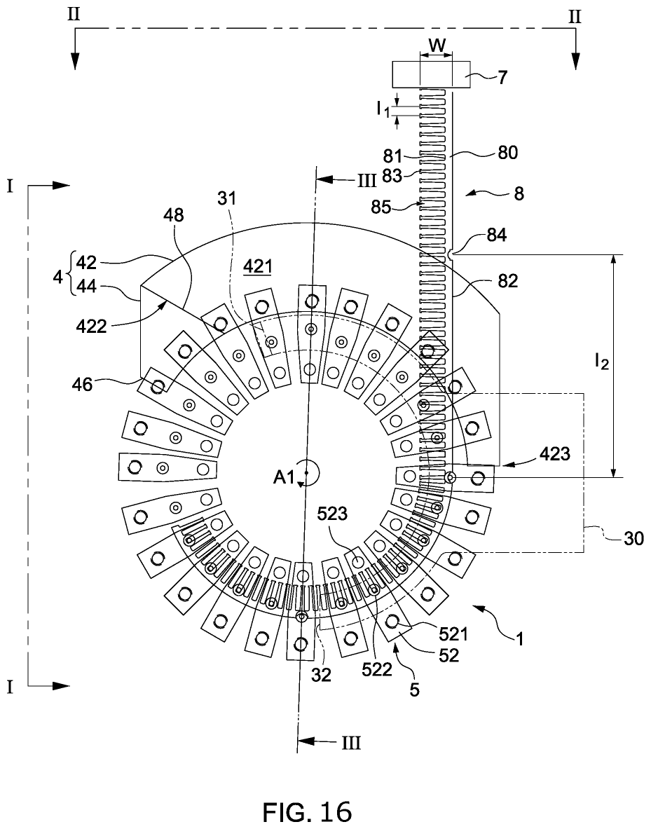

The following describes a system for manufacturing a stator core. FIG. 14 is a simplified front view of a system 100 for manufacturing a stator core 9 in accordance with an embodiment of the disclosure. FIG. 15 is an enlarged partial front view of the system 100 taken in box A of FIG. 14. FIG. 16 is a simplified top view of the system 100 taken in box A of FIG. 14. In accordance with some embodiments of the present disclosure, the system 100 for manufacturing a stator core 9 is provided. The system 100 includes a winding mechanism 1 and at least one positioning component 2. The positioning component 2 is located under the winding mechanism 1.

In some embodiments, the system 100 further includes a conveyor 7, a base 16 and a cylinder 18. The conveyor 7 is positioned in the proximity of the winding mechanism 1. The base 16 is located under the winding mechanism 1. The cylinder 18 is located on the base 16, and coupled to and under the winding mechanism 1 such that the cylinder 18 is positioned between the winding mechanism 1 and the base 16. In some embodiments, the positioning component 2 is fixed to the base 16 and spaced apart from the circumference surface of the cylinder 18 by a distance D1 as shown in FIG. 15. The foregoing distance D1 between the positioning component 2 and the cylinder 18 may substantially be equal to the width of a metal sheet 8. In this embodiment, the positioning component 2 includes four positioning pins 22, which are configured so that the positioning pins 22 are evenly distributed on four opposing sides of the base 16 such that a metal sheet 8 can be wound around an axis A1 and positioned within an area defined by and between the four positioning pins 22 and the cylinder 18.

As shown in FIG. 16, in some embodiments of the disclosure, the conveyor 7 is configured to provide a metal sheet 8 to the winding mechanism 1. The metal sheet 8 has a main portion 80 with an opposing first side 81 and second side 82. The straight sheet 8 further has numerous teeth 83 formed on and protruding from the first sides 81, and defines numerous cut-outs 85 between every two teeth 83 in a row at a first interval I1. The metal sheet 8 further has numerous notches 84 formed in the second side 82 in a row at a second interval I2. In this embodiment, the first interval I1 is shorter than the second interval I2 such that in a given portion of the metal sheet 8, the number of the cut-outs 85 is greater than that of the notches 84. In addition, the notches 84 may be semicircular in shape.

In some embodiments of the disclosure, when the metal sheet 8 is provided to the winding mechanism 1, the first side 81 of the metal sheet 8 is closer to the center of the winding mechanism 1 than the second side 82 is. In some other embodiments, the conveyor 7 is not required. A user may manually feed the metal sheet 8 to the winding mechanism 1.

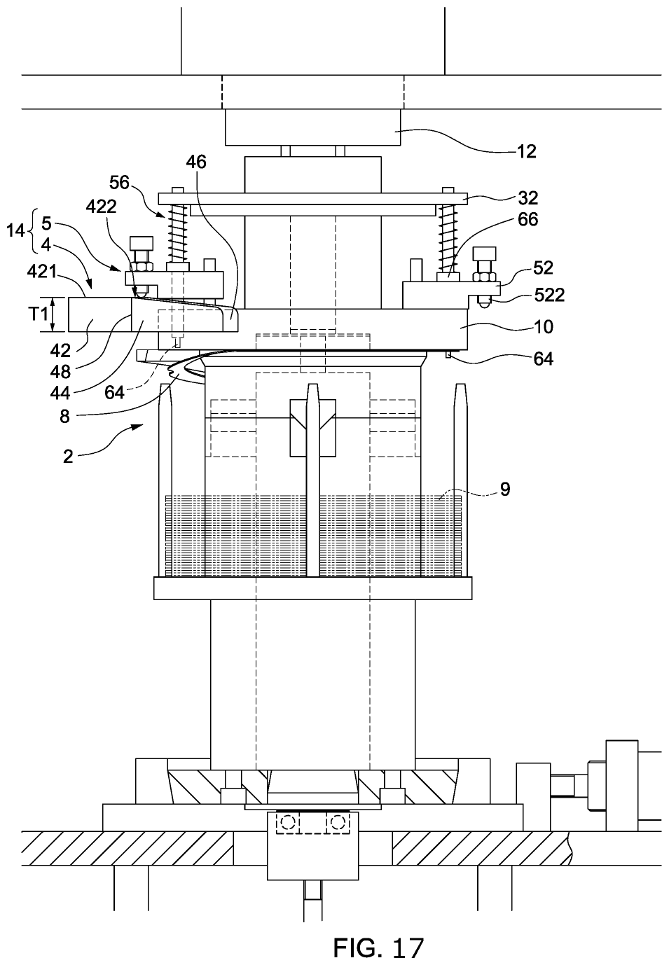

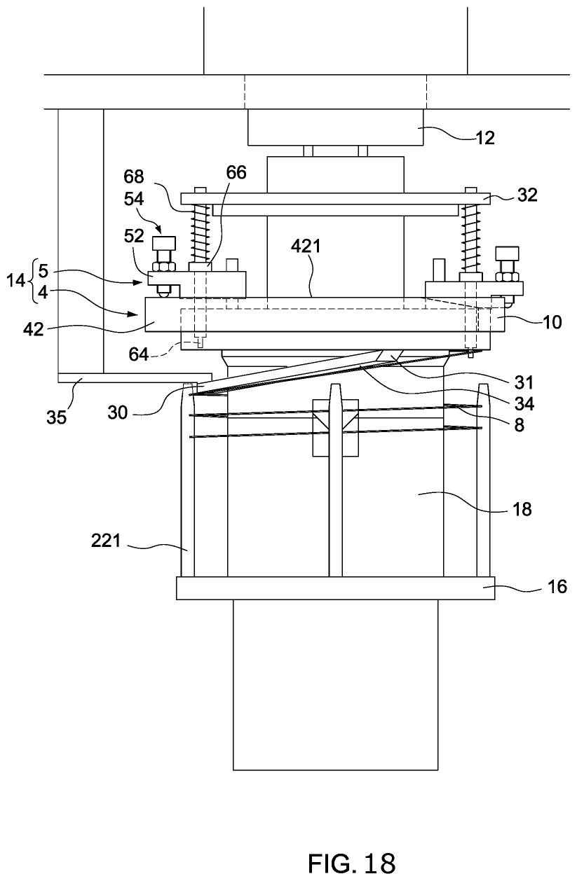

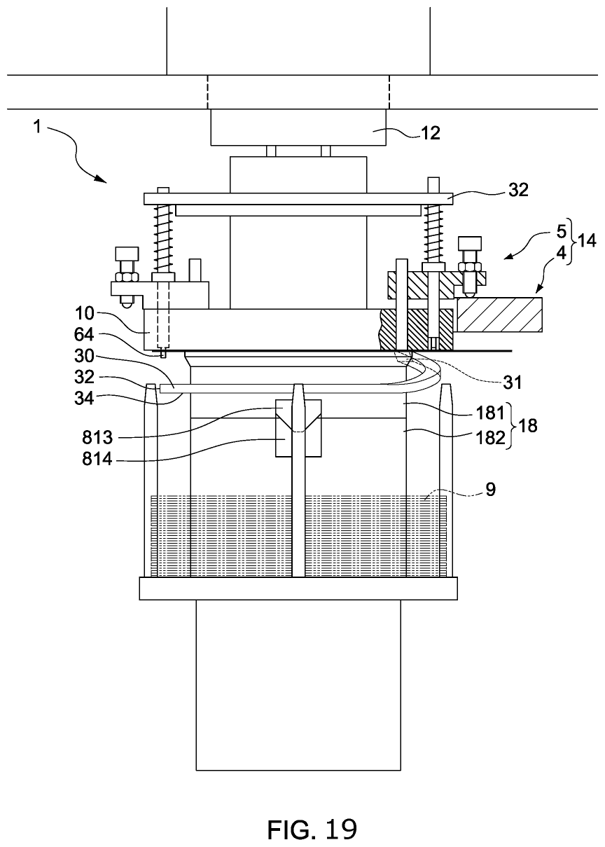

FIG. 17 is a simplified side view of the system 100 viewed from line I-I of FIG. 16. FIG. 18 is a simplified rear view of the system 100 viewed from line II-II of FIG. 3. FIG. 19 is a cross-sectional side view of the system 100 taken along line of FIG. 16. As shown in FIGS. 15-19, in some embodiments of the disclosure, the winding mechanism 1 is configured to wind the metal sheet 8 first and then release the sheet 8 after winding. That being said, the sheet 8 may be in a spiral shape during the winding. In some embodiments, the winding mechanism 1 includes a disk 10, an actuator 12, a guiding mechanism 14 and a plate 32. The disk 10 has numerous openings 102 formed in the circumference of the disk 10. The actuator 12 is coupled to the disk 10 and configured to rotate the disk 10 about the axis A1. In this embodiment as shown in FIG. 2, the actuator 12 has a shaft 13 coupled to the disk 10. The actuator 12 is configured to drive the shaft 13 to rotate, thereby rotating the disk 10. The guiding mechanism 14 is positioned adjacent to the disk 10 and configured to be releasably engaged with the metal sheet 8. The plate 32 is coupled to and surrounds the shaft 13 of the actuator 12.

In some embodiments of the disclosure, the guiding mechanism 14 includes an arc-shaped device 4 and numerous engaging components 5. The arc-shaped device 4 surrounds a part of the disk 10. In this embodiment, the arc-shaped device 4 surrounds less than half of the disk 10, as shown in FIG. 16. When the actuator 12 drives the disk 10 to move, the disk 10 may rotate with respect to the arc-shaped device 4. As shown in FIG. 17, while the disk 10 spins, the arc-shaped device 4 remains still. As shown in FIGS. 16-18, in some embodiments of the disclosure, the arc-shaped device 4 includes a leveled portion 42 and an inclined portion 44. The leveled portion 42 has substantially the same thickness T1 and a contact surface 421 which may be flat. The inclined portion 44 has a free end 46 and a connection end 48 connected to a first side 422 of the leveled portion 42. The free end 46 is tapered from the connection end 48 such that the height of the inclined portion 44 is decreased from the connection end 48 towards the free end 46. The leveled portion 42 has a second side 423 which is opposite to the first side 422 thereof.

In some embodiments of the disclosure, the engaging components 5 are circumferentially coupled to the disk 10 and configured to alternatively protrude out or retract into the disk 10 with the rotation of the disk 10. In this embodiment, there are 24 engaging components 5 disposed on the disk 10. In some other embodiments, the number of the engaging components 5 may be, for example, 12, 18 or 36. Besides, the engaging components 5 correspond to the openings 102 of the disk 10, respectively. When the engaging components 5 are driven to rotate by the actuator 12, each holding component 56 of the engaging component 5 may hold a respective part of the metal sheet 8 when the engaging component 5 does not interfere with the arc-shaped device 4, and releases the respective part of the metal sheet 8 when the engaging component 5 interferes with the arc-shaped device 4.

The following describes the configuration of the engaging components 5 in accordance with some embodiments of the disclosure. Each of the engaging components 5 includes a connecting board 52, an interference component 54, a holding component 56 and a guiding rod 58.

In some embodiments of the disclosure, the connecting board 52 is provided between the disk 10 and the plate 32 as shown in FIG. 2. The connecting board 52 has a first orifice 521, a second orifice 522 and a third orifice 523 arranged in series. In this embodiment, the third orifice 523 is the closest orifice to the center of the disk 10 among the three orifices 521-523, and the second orifice 522 is located between the first orifice 521 and the third orifice 523. The first orifice 521 is located above and radially beyond the periphery of the disk 10. The second orifice 522 and the third orifice 523 are located above the disk 10. The interference component 54 is fixed in the first orifice 521, and the interference component 54 may movably interfere with the arc-shaped device 4 in a part of its rotation path. The holding component 56 is connected to the connecting board 52. The holding component 56 may also penetrate through the disk 10 towards the positioning component 2 through the second orifice 522 and the respective one of the openings 102 in the disk 10 or retract back into the disk 10. The guiding rod 58 is affixed to the disk 10 and passes through the third orifice 523.

In some embodiments of the disclosure, each holding component 56 includes a fixing rod 60, a guiding pin 64, a block 66 and an elastic component 68. The fixing rod 60 has a first end 61 and a second end 62. The first end 61 is connected to the plate 32, and the second end 62 is connected to a block 66. The guiding pin 64 passes through the second orifice 522 and the respective opening 102 in the disk 10. The guiding pin 64 is configured to move along the lengthwise direction of the fixing rod 60 so as to protrude out of the disk 10 or retract back into the disk 10. In addition, the guiding pin 64 is configured so that the size of the guiding pin 64 may be suitable for a distal end of the guiding pin 64 to be inserted into the cut-out 86 of the metal sheet 8. In some embodiments, the block 66 is affixed to the guiding pin 64. The block 66 has a channel therein for receiving the second end 62 of the fixing rod 60. The elastic component 68 surrounds the fixing rod 60 and is positioned between the plate 32 and the block 66. The elastic component 68 may be, for example, a compression spring. In some other embodiments, the guiding pin 64 is integral with the fixing rod 60 such that the guiding pin 64 and the fixing rod 60 are able to move together.

In some embodiments of the disclosure, the interference component 54 includes a contact member 55 and a nut 57. The contact member 55 may be a screw which has a head 551 and a body 552. The body 552 is connected to the head 551 and secured in the first orifice 521. The body 552 may be integral with the head 551. A distal end of the body 552 is configured to be in releasable contact with the arc-shaped device 4. The contact member 55 passes through the nut 57 that is secured between the head 551 of the contact member 55 and the connecting board 52.

When the actuator 12 initiates to drive the winding mechanism 1, the engaging component 5 is rotated along with the disk 10 in a clockwise direction, as shown in FIG. 16. As shown in FIG. 15 and the right side of FIG. 17, when the interference component 54 does not interfere with the arc-shaped device 4, the elastic component 68 presses against the connecting board 52 to a lower position such that the block 66 is rested on the connecting board 52 and the connecting board 52 abuts against the disk 10. This allows the guiding pin 64 to protrude out of the disk 10. Meanwhile, as shown in FIGS. 15, 17, and 19, the guiding pins 64 are inserted into some of the cut-outs 86 of the straight sheet 8 such that the guiding pins 64 are engaged with the metal sheet 8 to wind and carry the metal sheet 8 while the engaging components 5 keep on rotating. The metal sheet 8, consequently, is carried and wound around by the engaging components 5 to form a spiral shape.

Then, as shown on the left side of FIG. 17, when the engaging component 5 is rotated over the arc-shaped device 4, the interference component 54 is lifted up as a result of an interference with the arc-shaped device 4 which serves as a riser in order to drive the guiding pin 64 of the holding component 56 to be retracted into the respective opening 102 in the disk 10. At this time, the part of the wound sheet 8 starts to fall due to the disengagement from the engaging component 5. In this embodiment, when the interference component 54 interferes with the arc-shaped device 4, the body 552 of the contact member 55 is in contact with the inclined portion 44 of the arc-shaped device 4. The interference component 54 starts to be lifted up by the inclined portion 44 until the interference component 54 reaches the leveled portion 42 as shown in FIGS. 4-5. At this time, the connecting board 52 is moved to an upper position which is higher than the lower position. Since the contact surface 421 of the leveled portion 42 with which the interference component 54 is in contact is flat, the interference component 54 may not rise to a position higher than the upper position. Moreover, the connecting board 52 also lifts the guiding pin 64 up to be retracted into the disk 10 such that the guiding pin 64 is disengaged from the teeth of the sheet 8. The part of the wound sheet 8 which is disengaged from the guiding pin 64 has no support from anything such that the part of the wound sheet 8 starts to helically fall towards the positioning component 2 due to gravitation. In the meantime, the block 66 is also lifted up by the connecting board 52 so as to compress the elastic component 68.

When the interference component 54 rotates over the second end of the leveled portion 42, the connecting board 52 and the guiding pin 64 rotate horizontally because the interference component 54 keeps the interference relationship with the flat contact surface 421 of the leveled portion 42, as shown in FIG. 18.

As shown on the right side of FIG. 2, when the interference component 54 rotates across the second end 423 of the leveled portion 42, the interference component 54 starts to disengage with the arc-shaped device 4. Given that the interference component 54 is not in contact with the arc-shaped device 4 at this moment, the elastic component 68 exerts a biasing force to push the block 66 and the connecting board 52 down to the lower position such that the guiding pin 64 may protrude out of the disk 10 again to carry another part of the sheet 8.

Furthermore, in accordance with some embodiments of the disclosure, no matter whether the connecting board 52 is pushed to move up or down, the connecting board 52 has to move along the guiding rod 58, which avoids some undesirable radial movements of the connecting board 52, thereby stabilizing the operation of the engaging component 5.

In accordance with some embodiments of the disclosure, as shown in FIGS. 15 and 18-19, the system 100 further includes a guiding slope 30 helically extending from the winding mechanism 1 towards the base 16 around a part of the circumferential surface of the cylinder 18. In this embodiment, the guiding slope 30 has an upper end 31 and a bottom end 32. The top end 31 may be approximately under the inclined portion 44. The bottom end 32 is positioned at another side of the base 16 and is closer to the base 16 than the upper end 31 is. In addition, as shown in FIGS. 15 and 18, the system 100 may further include a support 35 connected to the guiding slope 30 for supporting the guiding slope 30. It is understood that when the disk 10 turns, the guiding slope 30 and the support 35 do not turn. Accordingly, when the wound sheet 8 falls from the guiding pin 64, the fallen sheet 8 may abut against a bottom surface 34 of the guiding slope 30 in order to direct the sheet 8 to move downward towards the positioning component 2.

In accordance with some embodiments of the disclosure, the at least one positioning component 2 is elongated and disposed along the direction of the axis A1. In this embodiment, the positioning component 2 includes four positioning pins 22 symmetrically and evenly located around the cylinder 18. The positions of the four positioning pins 22 correspond to the notches 84 of the sheet 8, respectively. In some embodiments, the four positioning pins 22 are tapered upward such that the top (i.e., distal end) of the positioning pins 22 are conical in shape. Also, the shapes of the notches 84 substantially match with those of the corresponding positioning pins 22. In some embodiments, the positioning pins 22 are made of metal. The positioning component 2 is configured to, while the disk 10 rotates, collect and stack up the sheet 8 to form a stator core 84 having at least one groove 86 made of the notches 84 that align with each other by matching the notches 84 with the positioning pins 22 of the positioning component 2.

In some embodiments of the disclosure, since the cylinder 18 is coupled to the winding mechanism 1, in the event that the actuator 12 drives the disk 10 to rotate, the cylinder 18, the base 16, and the positioning component 2 rotate accordingly. As shown in FIG. 18, in some embodiments, when the sheet 8 starts to fall, one of the notches 84 may fall to a position in the proximity of a first one 221 of the positioning pins 22. Since the shape of the notches 84 matches with that of the positioning pins 22, a part of the metal sheet 8 is fitted to the first positioning pin 221 via the engagement of the notch 82 to the first positioning pin 221. Then, another part of the sheet 8 also falls and is fitted to a second positioning pin 22 next to the first positioning pin 22 while the disk 10 keeps rotating. Afterwards, yet another part of the sheet 8 falls, and is then fitted to a second one of the positioning pins 22. Hence, the wound sheet 8 can be wound around the cylinder 18 and fitted to the positioning pins 22.

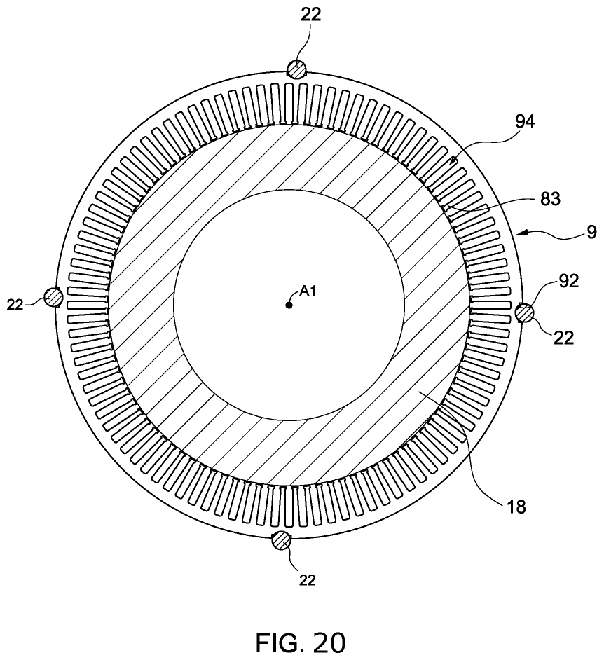

As shown in FIGS. 19 and 20, which is a top view of the cylinder 18 and the positioning component 2 of the system in FIG. 14, after several rounds of rotation, the wound sheet 8 is stacked up to form a stator core 9 with several grooves 92. Specifically, the stator core 9 is a structure with multiple layers and has a certain height. The respective groups of notches 84 are automatically aligned with the four positioning pins 22 such that the notches 84 are stacked up in an orderly manner to form four grooves 92 on the outer circumferential surface of the multi-layer structure 9, respectively. In other words, the notches 84 are provided on the outer circumference of the sheet 8 to form the groove 92. In addition, the cut-outs 86 are stacked up to form the slots 94 between the teeth 83 on the inner circumference of the sheet 8. In this embodiment, the number of slots 94 and teeth 83 may be, but are not limited to, 96. The number of grooves of the stator core may be more than or equal to that of the positioning pins 22.

As shown in FIG. 14, in some embodiments of the disclosure, the system 100 further includes a cutting component 7 positioned adjacent to the winding mechanism 1. In this embodiment, the cutting component 7 may be positioned under the arc-shaped device 4. When the metal sheet 8 is stacked up to have a certain height, the cutting component 7 is configured to automatically cut the sheet 8 off into two pieces. One piece of the sheet 8 wound around the cylinder 18 forms a first stator core 9; the other piece of the sheet 8 held by the winding mechanism 1 will be later wound and stacked up to form another stator core 9. In this embodiment, the cutting component 7 is designed so that in response to a signal indicating that the disk 10 rotates for a certain number of revolutions, the cutting component 7 located at a certain location cuts the sheet 8 off into two pieces.

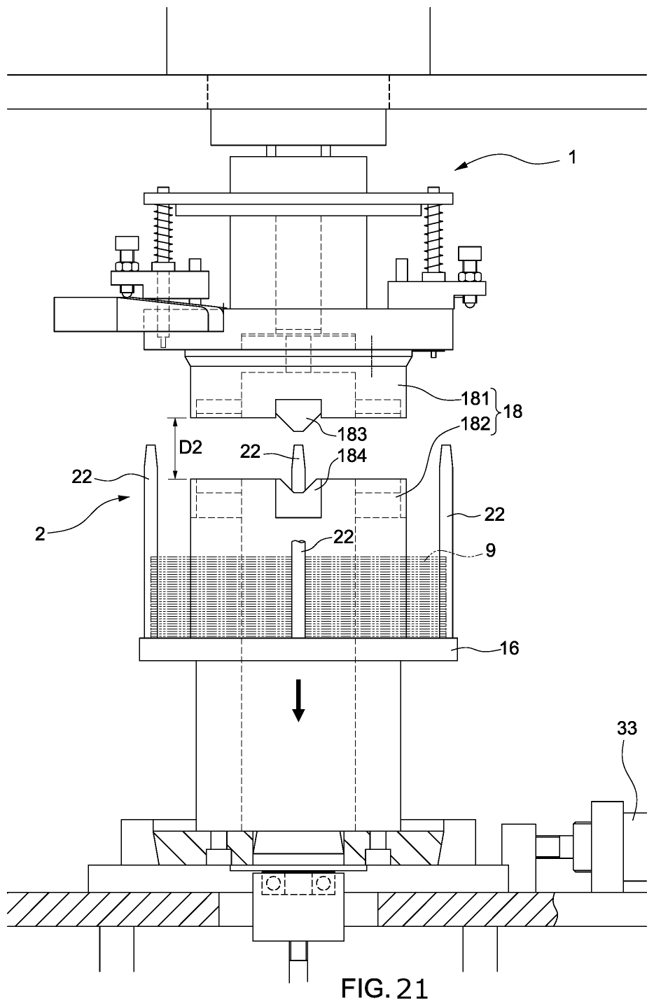

FIGS. 19 and 21 illustrate a simplified side view of the system 100 in which a first segment 181 of a cylinder 18 is disengaged from a second segment 182 of the cylinder 18 in accordance with an embodiment of the disclosure. The first segment 181 is affixed to the winding mechanism 1. The second segment 182 is located on the base 16 and releasably engaged with the first segment 181. When the stator core 9 is formed, the second segment 182 is disengaged with the first segment 181 so as to be spaced apart from each other by a distance D2. The stator core 9 may be taken out through the space between the second segment 182 and the first segment 181 for the next manufacturing process; for example, the bonding process.

In some embodiments of the disclosure, the cylinder 18 further includes a first matching component 183 and a second matching component 184 that are releasably engaged with each other. The first matching component 183 is located on the first segment 181. The second matching component 184 is located on the second segment 182. The shape of the first segment 181 matches with the shape of the second segment 182. For example, the first segment 181 has a wedge-shaped protrusion. The second segment 182 has a recess, and the shape of which corresponds to that of the wedge-shaped protrusion. When the first segment 181 is engaged with the second segment 182, the combination of the first segment 181 and the second segment 182 facilitates the alignment of the first segment 181 with the second segment 182 of the cylinder 18.

As shown in FIGS. 14 and 21, in some embodiments of the disclosure, the system 1 further includes a moving actuator 32 connected to the base 16. The moving actuator 32 is configured to drive the second segment 182 of the cylinder 18 to move along the axial direction Al of the cylinder 18, such that the first segment 181 can be disengaged from the second segment 182. In some other embodiments, the system 1 further includes another moving actuator 33 configured to drive the second segment 182 of the cylinder 18 to move along the radial direction of the cylinder 18. The second segment 182 of the cylinder 18 may be moved out and is not directly under the winding mechanism 1. It is therefore convenient for a user to take the stator core 9 out of the second segment 182 from the top of the stator core 9 without hindrance, since there are not any components above the second segment 182. Moreover, in some other embodiments, the system 1 further includes yet another moving actuator 34 configured to move vertically in order to separate the second segment 182 of the cylinder 18 from the stator core 9. Then, the stator core 9 can be transported to the next work station instead of being carried by hand.

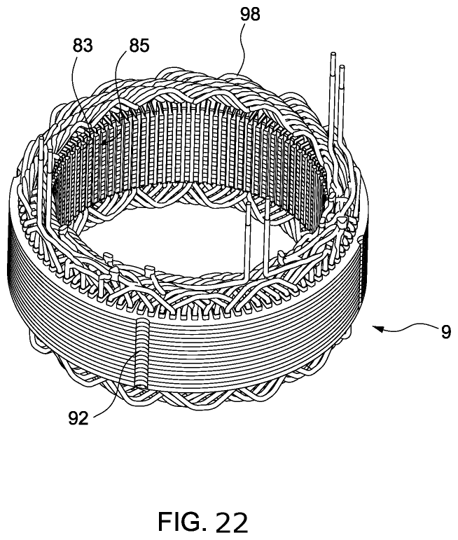

As shown in FIG. 22, which is a perspective of a stator core 9 in accordance with an embodiment of the disclosure, after the stator core 9 is taken out of the system 1, insulation liners may be provided to slots 94, and wires 98 may be provided to be wound around the teeth 83 as well as in the slots 94 so as to form several coils on the stator core 9. After the stator core 9 with the coils are assembled with a rotor, a first housing and a second housing are installed outside the rotor and the stator core for protection. Four fixing members, for example, screws or bolts, may pass through the four grooves 92 of the stator core 9 for the purpose of being affixed to the first and second housings.

All in all, in accordance with some embodiments of the disclosure, the winding mechanism may collect and wind around a sheet before releasing the sheet, which is wound around to have a spiral shape. The positioning component, which is located under the winding mechanism, may position and stack up the wound sheet to form a stator core. Thanks to the alignment of the notches of the sheet with the positioning component, e.g., at least one positioning pin, the layered sheet may be stacked up in an orderly fashion to form the stator core. No user or worker is required to stack up or arrange the sheet, thereby enhancing the manufacturing efficiency and reducing labor cost.

It is understood that many engaging components, sheets, guiding slopes, and other components may be omitted in the figures in order to clearly illustrate other parts of the system 1. For example, in FIGS. 14-15, 17-19 and 21, only two or three engaging components are shown in the figures, but in this embodiment, the number of the engaging components is, but not limited to, 24. For example, in FIGS. 17 and 21, guiding slopes are omitted.

Specific components of an insertion system and related methods for insertion have been described. It should, however, be apparent to those skilled in the art that many more modifications besides those already described are possible without departing from the inventive concepts herein. The inventive subject matter, therefore, is not to be restricted except in the spirit of the present disclosure. Moreover, in interpreting the present disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Embodiments of the present invention include the following Concepts:

Concept 1. A system for manufacturing a stator core, the system comprising: a winding mechanism configured to wind and release a sheet having a plurality of notches at intervals; and at least one positioning component located under the winding mechanism and corresponding to the plurality of notches.

Concept 2. The system of Concept 1, further comprising: a base; and a cylinder located on the base and coupled to the winding mechanism, the at least one positioning component being fixed to the base and spacing apart from the circumference surface of the cylinder by a distance that is substantially equal to the width of the sheet.

Concept 3. The system of Concept 2, wherein the at least one positioning component includes four positioning pins symmetrically located around the cylinder, the four positioning pins corresponding to the plurality of notches.

Concept 4. The system of Concept 2, further comprising: a guiding slope helically extending from the winding mechanism towards the base around a part of the circumferential surface of the cylinder.

Concept 5. The system of claim 2, wherein the cylinder further comprises: a first segment affixed to the winding mechanism; and a second segment located on the base and releasably engaged with the first segment.

Concept 6. The system of Concept 5, wherein the cylinder further comprises: a first matching component located on the first segment; and a second matching component located on the second segment, the shape of the first segment matches with the shape of the second segment.

Concept 7. The system of Concept 4, further comprising: a moving actuator connected to the base and configured to drive the second segment of the cylinder to move along the axial direction thereof.

Concept 8. The system of Concept 1, wherein the winding mechanism comprises: a disk; an actuator configured to drive the disk to rotate; and a guiding mechanism adjacent to the disk and configured to releasably engage with the sheet.

Concept 9. The system of Concept 8, wherein the guiding mechanism comprises: an arc-shaped device surrounding a part of the disk; and a plurality of engaging components circumferentially coupled to the disk, the actuator is configured to rotate each engaging component to hold a part of the sheet when the engaging component does not interfere with the arc-shaped device and release the part of the sheet when the engaging component interferes with the arc-shaped device.

Concept 10. The system of Concept 9, wherein the disk has a plurality of openings formed in the circumference of the disk, each engaging component comprises: a connecting board having a first orifice, a second orifice and a third orifice arranged in series, wherein the second orifice and the third orifice are located above the disk; an interference component fixed in the first orifice, and the interference component interferes with the arc-shaped device in a part of its rotation path; a holding component connected to the connecting board and protruding out of the disk towards the positioning component through the second orifice and the respective one of the plurality of the openings in the disk; and a guiding rod affixed to the disk and passing through the third orifice.

Concept 11. The system of Concept 10, wherein the interference component is configured that when the engaging component is rotated over the arc-shaped device, the interference component is lifted up as a result of an interference with the arc-shaped device so as to drive the holding component to be retracted into the respective opening in the disk.

Concept 12. The system of Concept 11, wherein the winding mechanism further comprises a plate connected to and surrounding the actuator, the connecting board is provided between the disk and the plate, and each holding component comprises: a fixing rod having a first end affixed to the plate and extending towards the disk; a guiding pin passing through the second orifice and the respective opening in the disk and being configured to move along the lengthwise direction of the fixing rod; a block affixed to an end of the guiding pin, the block having a channel therein for receiving a second end of the fixing rod; and an elastic component surrounding the fixing rod and positioned between the plate and the block.

Concept 13. The system of Concept 12, wherein when the interference component does not interfere with the arc-shaped device, the block is rested on the connecting board, and when the interference component interferes with the arc-shaped device, the block is lifted to compress the elastic component.

Concept 14. The system of Concept 13, wherein the guiding pin is releasably engaged with teeth of the sheet, the teeth are formed in the inner circumference of the sheet, and the plurality of notches are provided in the outer circumference of the sheet.

Concept 15. The system of Concept 11, wherein the interference component comprises: a contact member having a head and a body connected to the head and secured in the first orifice, an end of the body being configured to be in contact with the arc-shaped device; and a nut through which the contact member passes, the nut being secured between the head of the contact member and the connecting board.

Concept 16. The system of Concept 9, wherein the arc-shaped device comprises: a leveled portion having substantially the same thickness; and an inclined portion having a free end and a connection end connected to one side of the leveled portion; the free end is tapered.

Concept 17. The system of Concept 1, further comprising: a conveyor configured to provide the sheet to the winding mechanism wherein the sheet is in a spiral shape during the winding.

Concept 18. The system of Concept 1, further comprising: a cutting component positioned adjacent to the winding mechanism and configured to cut the sheet off

Concept 19. A system for manufacturing a stator core, the system comprising: a winding mechanism configured to wind and release a sheet having a plurality of notches at intervals; and at least one positioning component located under the winding mechanism and configured to collect and stack up the sheet to form a stator core having at least one groove made of the plurality of notches that are aligned with each other by matching the notches with the positioning components.

Concept 20. A system for manufacturing a stator core, the system comprising: a winding mechanism comprising: a disk; an actuator configured to rotate the disk about an axis; and a plurality of engaging components circumferentially coupled to the disk, the actuator being configured to rotate each engaging component through the disk to alternatively protrude out or retract into the disk with the rotation of the disk; and at least one positioning component located under the winding mechanism wherein the at least one positioning component is elongated and is disposed along the direction of the axis.

Specific components of an insertion system and related methods for insertion have been described. It should, however, be apparent to those skilled in the art that many more modifications besides those already described are possible without departing from the inventive concepts herein. The inventive subject matter, therefore, is not to be restricted except in the spirit of the present disclosure. Moreover, in interpreting the present disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An system for inserting insulation strips into slots in a wound stator, the system comprising:
a first provider configured to provide a first insulation strip;
a second provider configured to provide a second insulation strip; and
an inserting component configured to simultaneously insert the first insulation strip and the second insulation strip spacing apart from the first insulation strip into two slots of the wound stator, respectively.

2. The system of claim 1, further comprising:
a rotating component configured to accommodate and rotating the wound stator for sequent insertions of the insulation strips wherein the two slots of the wound stator are next to each other.

3. The system of claim 1, wherein the first provider comprises:
a conveyor configured to convey an insulation belt; and
a cutting unit configured to cut a part of the insulation belt to provide the first insulation strip.

4. The system of claim 3, wherein the first provider further comprises:
a material container configured to accommodate at least one of the insulation belt, the material container having an opening; and
a pushing component configured to push the insulation belt out of the material container via the opening to the conveyor.

5. The system of claim 4, wherein the first provider further comprises:
a material detector coupled to the pushing component and configured to detect a usage of the insulation belt.

6. The system of claim 3, wherein the first provider further comprises:
a transporting unit configured to move the first insulation strip from a first position to a second position.

7. The system of claim 6, wherein the transporting unit is configured to pivot about a right angle to move the first insulation strip from the first position to the second position.

8. The system of claim 3, wherein the first provider further comprises:
a first platform configured to carry the insulation belt; and
a second platform on which the inserting component is located.

9. The system of claim 8, wherein the first platform includes an aperture for the insulation belt to pass through, wherein the cutting unit is located over the aperture and the second platform is located under the aperture.

10. The system of claim 1, wherein the inserting component comprises:
an actuator; and
an inserting rod mounted on the actuator, the actuator being configured to drive the inserting rod to move into a space surrounded by the rotating component.

11. The system of claim 10, wherein the inserting components further comprises two protruding parts mounted on the inserting rod and each having a width greater than that of each of the slots of the wound stator for deforming the slots of the wound stator so that the first insulation strip and the second insulation strip can be smoothly inserted into the slots of the wound stator.

12. The system of claim 11, further comprising:
an expanding mechanism positioned next to the inserting component, the expanding mechanism including two expanding guide rods configured to radially move into and expand the two slots,
when the protruding parts are inserted into the two slots, the expanding guide rod is pushed out of the two slots axially.

13. The system of claim 1, further comprising:
a transferring mechanism configured to place the wound stator on the rotating component for insertions of the insulation strips and removing another wound stator with insulation strips in the slots from the rotating component.

14. The system of claim 13, wherein the transferring mechanism includes a first robotic device, the first robotic device has a first arm which is rotatable for at least 180 degree and a first claw and a second claw connected to the two ends of the first arm, the first claw being configured to carry the wound stator to and taking the another wound stator from the rotating component;

15. The system of claim 14, wherein the transferring mechanism further includes a second robotic device configured to provide the wound stator to and taking the another wound stator from the first robotic device wherein the second claw of the first robotic device is configured to carry the another wound stator to and taking the wound stator from the second robotic device.

16. A method for inserting insulation strips into slots in a wound stator, the method comprising the following steps:
providing a first insulation strip and a second insulation strip spacing apart from the first insulation strip;
simultaneously inserting the first insulation strip and the second insulation strip into two slots of the wound stator, respectively;
rotating the wound stator; and
providing a third insulation strip and a fourth insulation strip spacing apart from the third insulation strip; and
simultaneously inserting the third insulation strip and the fourth insulation strip into another two slots of the wound stator, respectively wherein the two slots are next to the another two slots.

17. The method of claim 16, wherein the step of providing the first insulation strip and the second insulation strip further comprises:
conveying a first insulation belt linearly in a first direction; and
cutting a part of the first insulation belt to provide the first insulation strip.

18. The method of claim 17, wherein after the step of cutting a part of the first insulation belt to provide the first insulation strip, the method further includes the step of rotating the first insulation strip from a first position to a second position by an right angle.

19. The method of claim 15, prior to the step of simultaneously inserting the first insulation strip and the second insulation strip into two slots of the wound stator respectively, the method further includes the step of expanding the slots in the wound stator.

20. The method of claim 15, further comprises the step of providing a transferring mechanism configured to place the wound stator on a rotating component for rotating the wound stator and removing another wound stator with insulation strips in the slots thereof from the rotating component.
